(19) United States
(12) Patent Application Publication
(10) Pub. No.: US 2026/0368667 A1
(43) Pub. Date: Nov. 19, 2026

(54) METHOD FOR DERIVING GEOGRAPHIC METRICS AND RISK IDENTIFICATION OF TREES

(71) Applicant: Treeswift Inc., Philadelphia, PA (US)

(72) Inventors: Vaibhav Rajkiran Arcot, Philadelphia, PA (US); James John Paulos, Lancaster, PA (US); Michael Joshua Shomin, Merion Station, PA (US); Grace Li, New York, NY (US); Ryan Yi-Shen Yeh, Seattle, WA (US); Gibryon Gushan Bhoraj, Woodside, NY (US); Bianca Rahill-Marier, New York, NY (US); Andrey Pak, Philadelphia, PA (US)

(21) Appl. No.: 19/678,748

(22) Filed: May 15, 2026

Related U.S. Application Data
(60) Provisional application No. 63/806,543, filed on May 15, 2025.

(51) Int. Cl. G06Q 10/0631; G06T 7/73; G06V 10/44; G06V 20/10

(52) U.S. Cl. CPC G06Q 10/06316; G06T 7/73; G06V 10/44; G06V 20/176; G06V 20/188; G06T 2207/30184; G06T 2207/30188

(57) ABSTRACT

A method includes: accessing scan data captured by a mobile scanning system and depicting a set of trees; and identifying an infrastructure object proximal the set of trees. The method includes, for a tree in the set of trees: detecting a canopy of the tree, extending above the infrastructure object; deriving a tree boundary encompassing the tree based on features of the tree detected in the scan data; calculating a strike risk score, representing strike risk of the tree on the infrastructure object, based on the canopy of the tree and intersection of the tree boundary with the infrastructure object during simulated felling of the tree; generating a work plan specifying strike risk mitigation action for trees in the set of trees characterized by strike risk scores exceeding a threshold strike risk score; and serving the work plan to an operator portal.

### CROSS-REFERENCE TO RELATED APPLICATIONS

This Application claims the benefit of U.S. Provisional Application No. 63/806,543, filed on 15 May 2025, which is hereby incorporated in its entirety by this reference.

This Application is related to U.S. patent application Ser. No. 18/391,393, filed on 20 Feb. 2024, U.S. patent application Ser. No. 18/391,393, filed on 20 Dec. 2023, and U.S. patent application Ser. No. 18/199,863, filed on 19 May 2023, each of which is incorporated in its entirety by this reference.

### TECHNICAL FIELD

This invention relates generally to the field of environmental risk assessment and, more specifically, to a new and useful method for deriving geographic metrics and risk identification of trees in the field of environmental risk assessment.

### BRIEF DESCRIPTION OF THE FIGURES

FIG. 1 is a graphical representation of a method;

FIG. 2 is a schematic representation of one variation of the method;

FIG. 3 is a schematic representation of one variation of the method;

FIG. 4 is a flowchart representation of one variation of the method; and

FIG. 5 is a flowchart representation of one variation of the method.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. Method

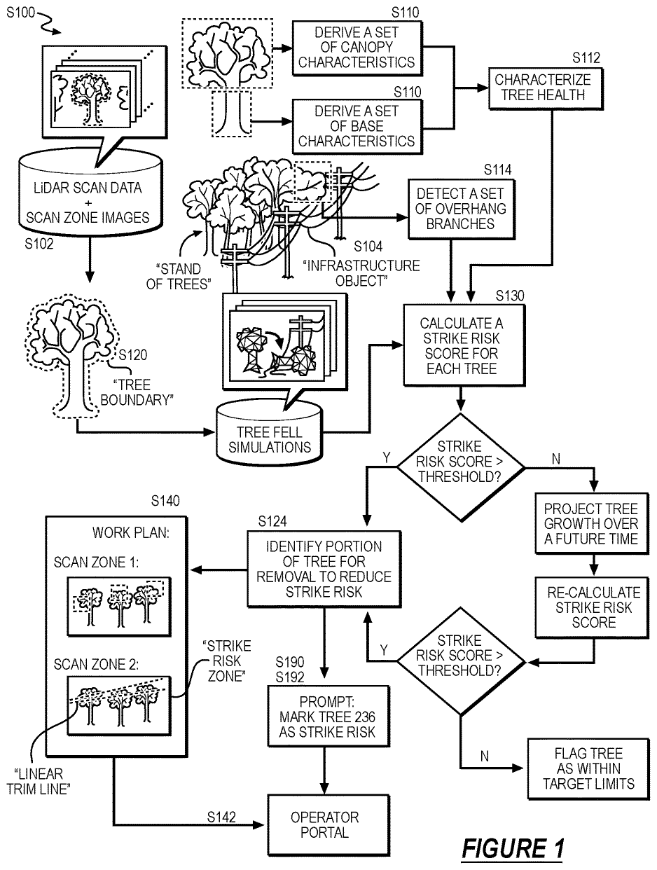

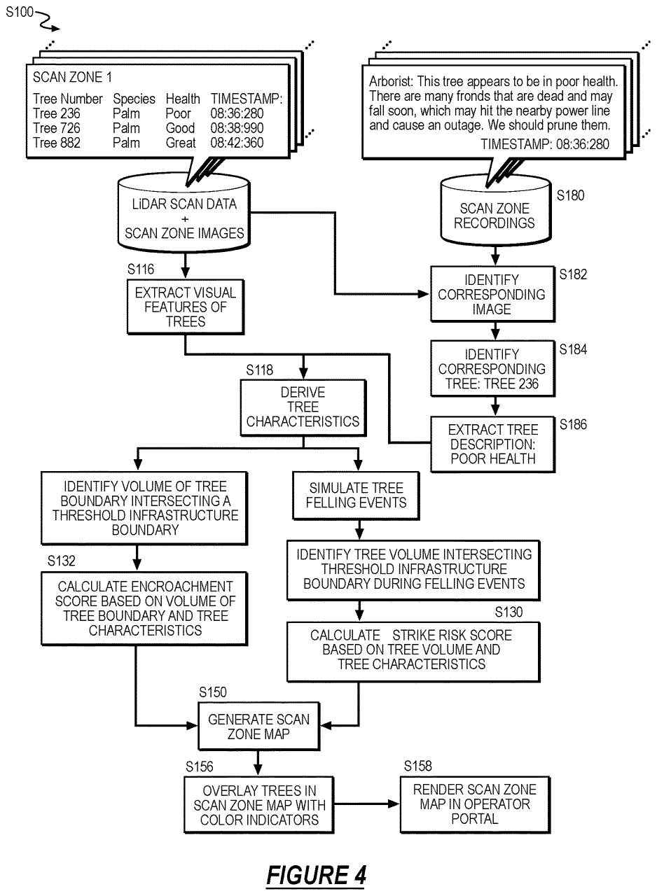

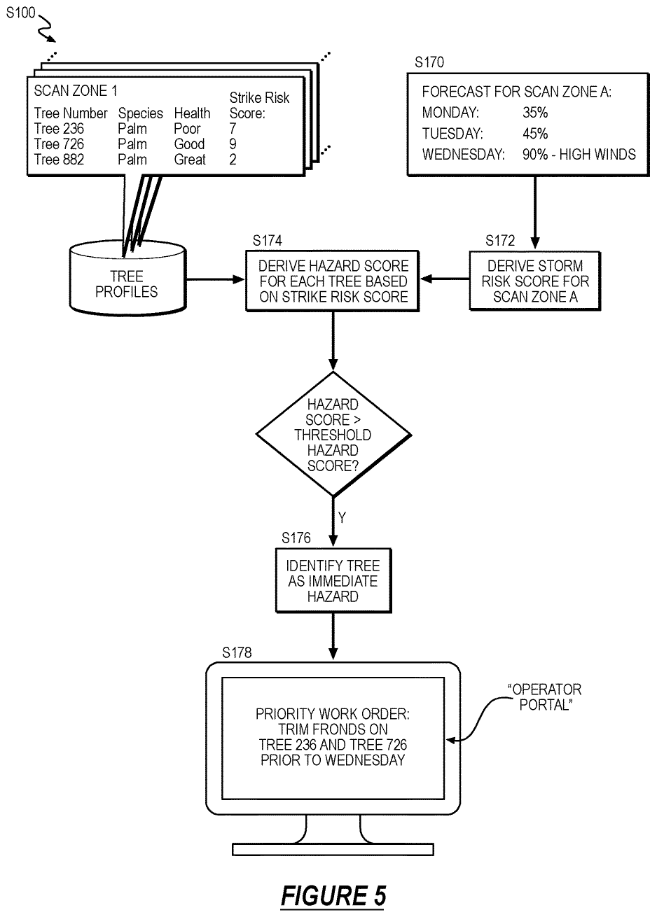

As shown in FIGS. 1-5, a method S100 includes: accessing a first set of scan data (e.g., two-dimensional image data, LiDAR scan data) captured by a mobile scanning system, the first set of scan data depicting a set of trees in Block 102; and detecting an infrastructure object, proximal the set of trees, in the first set of scan data in block S104.

The method S100 also includes, for each tree in the set of trees: extracting a set of canopy characteristics of the tree from the first set of scan data in Block S110; deriving a three-dimensional tree boundary encompassing the tree based on features of the first tree detected in the first set of scan data in Block S120; and calculating a strike risk score, representing a strike risk of the tree on the infrastructure object, based on intersection of the three-dimensional tree boundary with the infrastructure object during a simulated felling of the tree in Block S130.

The method S100 further includes: generating a work plan specifying strike risk mitigation action for trees in a first subset of trees, in the set of trees, characterized by strike risk scores exceeding a first threshold strike risk score in Block S140; and serving the work plan to an operator via an operator portal in Block S142.

### 1.1 Variation: Encroachment

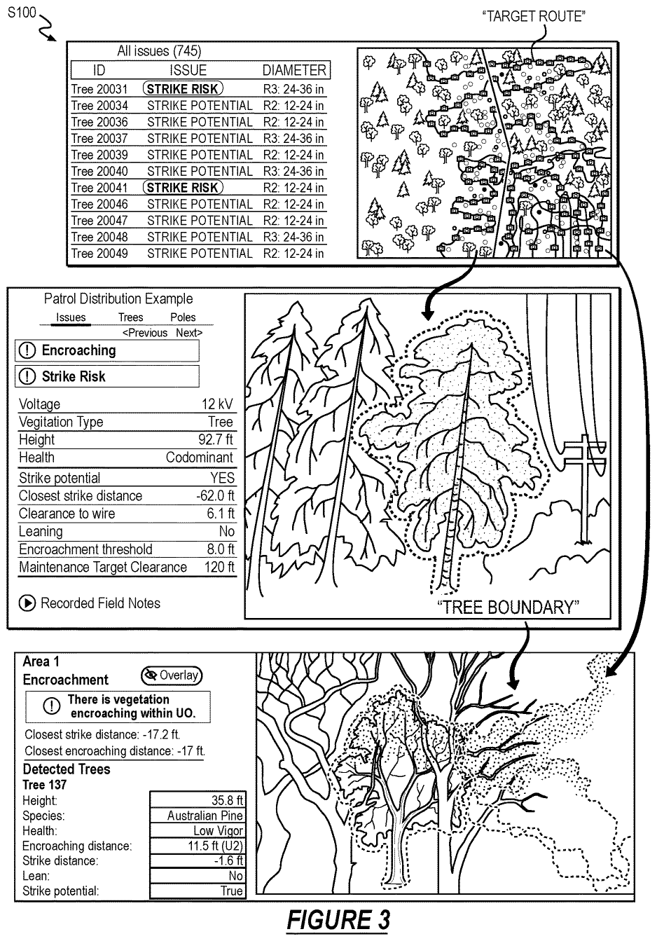

As shown in FIG. 3 one variation of the method S100 includes: accessing a first set of scan data captured by a mobile scanning system in a first scan zone, the first set of scan data depicting a set of trees in Block S102; detecting an infrastructure object, proximal the set of trees, in the first set of scan data in Block S104; defining a threshold boundary around the infrastructure object based on a regulatory threshold distance between tree boundaries and infrastructure objects, the threshold boundary defining a cylindrical volume encompassing the infrastructure object in Block S122; generating a map of the first scan zone in Block S150; and populating the map with an infrastructure representation of the infrastructure object and the threshold boundary in Block S152.

This variation of the method S100 also includes, for each tree in the set of trees: extracting a set of features of the tree from the first set of scan data in Block S116; deriving a set of tree characteristics based on the set of features in Block S118; defining a tree boundary encompassing the tree based on the set of features in Block S120; populating the map with a tree representation of the tree boundary in Block S154; calculating an encroachment score for the tree based on the set of tree characteristics, a volume of the tree boundary intersecting the threshold boundary, and a distance between the tree boundary and the threshold boundary in Block S132; and annotating the tree representation in the map with a color indicator representing the encroachment score in Block S156.

This variation of the method S100 further includes serving the map, annotated with color indicators representing encroachment scores of each tree in the set of trees, to an operator portal in Block S158.

### 1.2 Variation: Real-Time Feedback

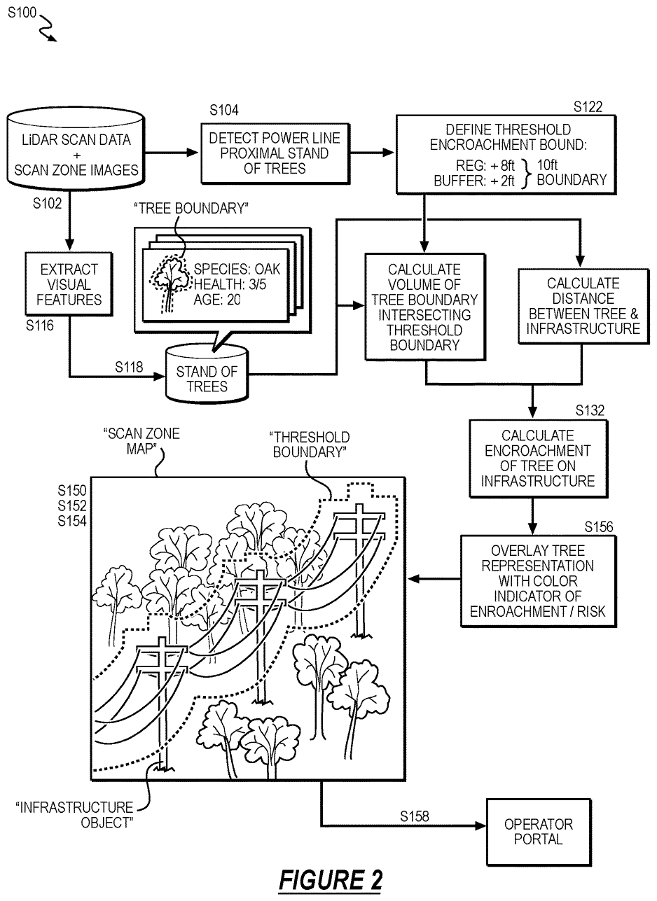

As shown in FIG. 2, one variation of the method S100 includes, during a first time period, while an operator traverses a target pathway intersecting an array of scan zones: accessing a first set of scan data captured by a mobile scanning system, carried by the operator, at a first scan zone in the array of scan zones, the first set of scan data depicting a set of trees occupying the first scan zone in Block S102; and detecting an infrastructure object, proximal the set of trees, in the first set of scan data in Block S104.

This variation of the method S100 also includes, for each tree in the set of trees: extracting a set of canopy characteristics of the tree from the first set of scan data in Block S110; detecting a set of canopy overhangs, extending above the infrastructure object, based on the set of canopy characteristics in Block S114; deriving a three-dimensional tree boundary encompassing the tree based on features detected in the first set of scan data in Block S120; and calculating a strike risk score, representing strike risk of the tree on the infrastructure object, based on the set of canopy overhangs and intersection of the three-dimensional tree boundary with the infrastructure object during simulated felling of the tree in Block S130.

This variation of the method S100 further includes, in response to the strike risk score exceeding a threshold risk score: identifying the tree as a strike risk for the infrastructure object in Block S190; and prompting the operator to physically mark the tree as the strike risk in Block S192.

### 2. Applications

Generally, Blocks of the method S100 can be executed by a computer system in conjunction with a mobile scanning system carried by an operator traversing a set of trees proximal a target infrastructure: to access a sequence of images captured by the mobile scanning system during traversal of an array of scan zones; to detect individual trees and a target infrastructure (e.g., powerlines, waterlines, buildings, homes) proximal the set of trees in these images; to derive a set of tree characteristics (e.g., tree health, tree species, three-dimensional tree boundaries) of individual trees in the set of trees based on visual features extracted from these images; and to characterize strike risks and/or encroachment risks of each tree in the set of trees to the target infrastructure based on these tree characteristics. The computer system can further: generate a map of the set of trees annotated with representations of strike risks and encroachment risks of individual trees; generate a work plan specifying strike risk mitigation action and/or encroachment mitigation actions for trees in the set of trees characterized by strike risks and/or encroachment risks to the target infrastructure; and serve the work plan to an operator for review and confirmation.

More specifically, the computer system can: compile image data captured via a mobile scanning system carried by an operator traversing a set of trees proximal a target infrastructure (e.g., an overhead powerline, an overhead transmission powerline, an overhead distribution powerline); detect trees and the target infrastructure in these images; characterize strike risks and encroachment risks posed by these trees to the target infrastructure based on three-dimensional models of these trees; generate a map of the set of trees annotated with color indicators representing strike risk scores and encroachment scores of individual trees and clusters of trees; and generate a work plan incorporating strike risk scores, encroachment scores, asset criticality, regulatory requirements, and budget constraints to prioritize maintenance actions for trees in the set of trees. In response to the operator confirming the work plan, the computer system can generate work orders specifying maintenance actions for trees characterized by strike risks and/or encroachment risks, thereby enabling the operator to efficiently deploy field crews to execute targeted mitigation actions across the set of trees.

Furthermore, the computer system can characterize a strike risk score for each tree in the set of trees by: defining a constellation of points representing a surface of the tree; defining a pivot at a base of the tree; for each point in the constellation of points, defining a vector that extends from the pivot to the point; for each vector in the set of vectors, simulating a rotation of the vector about the pivot in a simulated felling of the tree; and, in response to the vector intersecting the target infrastructure during the rotation, flagging the tree as a strike risk for the target infrastructure. The computer system can extend the simulation by defining a set of vertical planes through the pivot, each vertical plane characterized by a yaw angle relative to a reference direction; projecting the vector into each vertical plane; and simulating rotation of the vector about the pivot through each vertical plane. The computer system can then calculate the strike risk score proportional to a count of vector rotations, across the set of vectors and the set of vertical planes, exhibiting intersection between the vector and the target infrastructure during the rotation. Additionally, the computer system can detect a set of branches of the tree extending above the target infrastructure; calculate a branch volume of each branch from the first set of scan data; characterize a branch health of each branch based on visual features (e.g., discoloration, structural deformity, bark degradation) of the branch detected in the first set of scan data; and calculate a branch strike risk score for each branch proportional to the branch volume and inversely proportional to the branch health, thereby capturing strike risks posed by individual branches of the tree independent of the overall fall trajectory of the tree.

The computer system can also characterize an encroachment score for each tree in the set of trees by: defining a threshold boundary around the target infrastructure based on a regulatory threshold distance and/or an operator-defined buffer distance; and calculating an encroachment score for each tree based on the volume of the tree boundary intersecting the threshold boundary, the distance between the tree boundary and the threshold boundary, and tree characteristics of the tree (e.g., species, growth rate, age, health). In one variation, the computer system can characterize current encroachment, representing tree boundaries intersecting the threshold boundary, and proximate encroachment risk representing tree boundaries approaching the threshold boundary and predicted to intersect the threshold boundary within a forecast time window based on species-specific growth rates. The computer system can further classify trees into mandatory remediation categories and discretionary remediation categories based on regulatory penalties associated with trees intersecting the threshold boundary, thereby enabling the operator to prioritize mandatory remediation actions for trees subject to regulatory fines before addressing discretionary maintenance actions for trees characterized by lower encroachment scores.

Based on strike risk scores and encroachment scores of individual trees, the computer system can generate a work plan specifying maintenance actions for trees in the set of trees subject to a target resource allocation ingested from a customer-supplied source (e.g., a budget spreadsheet, a rate card defining per-action costs for trimming and removal). In particular, the computer system can: estimate a resource allocation value for each maintenance action specified in the work plan; and prioritize maintenance actions by a ratio of risk reduction per resource allocation value, thereby enabling the operator to deploy field crews to execute the highest-value maintenance actions within a budget constraint. Additionally, rather than generating individual per-tree work orders for clusters of trees characterized by routine trimming requirements, the computer system can: derive a linear trim line spanning the cluster of trees based on strike risk scores and geometries of trees in the cluster of trees, the linear trim line representing the minimum linear footage of trimming required to mitigate strike risks of the cluster to the target infrastructure; and generate a single work order specifying the linear footage of the linear trim line.

In one implementation, a computer system can execute Blocks of the method S100: to access a sequence of images captured by mobile scanning system, such as carried by an operator walking or mounted on a vehicle traversing near infrastructure (e.g., powerlines) within a wooded area, a set of trees, a forest, or another scan zone; to detect a population of trees and a target infrastructure (e.g., an overhead powerline, a an overhead transmission powerline, an overhead distribution powerline) proximal the population of trees in these images; to derive a set of tree characteristics (e.g., tree health, tree species, three-dimensional tree boundaries) of individual trees in this population of trees based on features extracted from these images; and to characterize risks (e.g., encroachment risk, strike risk) of each tree in this population of trees to the target infrastructure based on these tree characteristics. The computer system can further: generate or annotate a two-dimensional or three-dimensional map of this scan zone with representations of risks of these individual trees (e.g., with red overlays on representations of high-risk trees and green overlays on representations of low-risk trees); and to flag specific trees—characterized by excess risk—for further evaluation and/or maintenance (e.g., felling, pruning) by an operator.

Therefore, the computer system can: compile image data captured via a camera in a mobile pack carried by an operator traversing a scan zone and/or via a camera arranged on a vehicle traversing within the scan zone; detect trees and infrastructure in this zone; characterize risk posed by these trees to this infrastructure based on features detected in these images; and automatically highlight or direct operators to specific trees that pose specific risks-such as encroachment or strike risk-thereby enabling operators to more efficiently and accurately deploy resources to managing these trees and infrastructure. Furthermore, the computer system can: automatically generate work plans and work orders specifying maintenance actions for trees characterized by strike risks and encroachment risks; and serve these work plans and work orders to operators, thereby enabling operators to efficiently deploy field crews to execute targeted maintenance actions, reduce strike risks and encroachment risks across large and geographically complex sets of trees, and proactively mitigate public safety risks associated with trees proximal infrastructure.

### 2.1 Example

In one implementation, during a first time window, an operator (e.g., a human operator) may carry a mobile scanning system while traversing (i.e., walking along) a target pathway through a set of trees within a scan zone. During this traversal the mobile scanning system can: automatically capture a sequence of images depicting trees in this scan zone; and upload this sequence of images to a computer system (e.g., a remote server).

The computer system can then: stitch the sequence of images into a three-dimensional representation of the scan zone; detect infrastructure and derive three-dimensional tree boundaries and other characteristics (e.g., species, height, carbon volume, health, fire risk, pest risk) of these trees from these images and/or the three-dimensional representation of the scan zone; detect current encroachment risk and predict future encroachment risk of these trees based on their species and positions of their three-dimensional tree boundaries relative to the infrastructure; simulate felling of the three-dimensional tree boundaries of these trees to estimate strike risk posed by these trees to the infrastructure; and to highlight specific trees with high current encroachment risk, high predicted future encroachment risk, and/or strike risk for an operator, such as in a two-dimensional or three-dimensional map of the scan zone, in order to guide the operator toward more efficient, effective, and accurate deployment of resources to manage trees near this infrastructure.

Accordingly, the computer system can execute Blocks of the method to rapidly identify potential risks posed by trees to infrastructure (e.g., a powerline) within a scan zone and thus enable an operator to efficiently deploy targeted mitigation actions across a large population of trees to reduce such risks.

The method S100 is described herein as executed by a computer system (e.g., a remote server). However, Blocks of the method S100 can be executed by one or more entities accessing the network, by a local computer system, by the mobile scanning system, or by any other computer system-hereinafter a “computer system.”

### 3. Hardware

Generally, the method S100 can be executed by one or more elements within the system in conjunction with a computer system to detect and respond to tree conditions within a forest. The system can include: a mobile scanning system; a local controller; and an operator interface. In particular, the mobile scanning system can include a mobile pack, such as described in U.S. patent application Ser. No. 18/391,393, filed on 20 Feb. 2024, which is incorporated in its entirety by this reference. For example, the mobile pack (e.g., a backpack, a bag, a knapsack) can include: a set of (e.g., two) straps configured to contact shoulders of an operator; a chassis; a boom (e.g., a mast) extending from the chassis and above a head of an operator carrying the mobile pack; a geolocation module (e.g., a global positioning system) coupled to the boom; a sensor suite including optical sensors (e.g., an RGB camera, a hyper-spectral camera, a LIDAR sensor, an omnidirectional camera), proximity sensors, and/or ambient condition sensors (e.g., temperature sensor, humidity/moisture sensor, light intensity sensor) coupled to the boom; an integral display (e.g., output device) removably coupled to the chassis; a housing coupled to the chassis; a wireless communications module (i.e., local controller) arranged in the housing; and a battery module arranged in the housing.

In one variation, the housing of the mobile pack includes a suite of proximity sensors located along the first side and the second side of the longitudinal axis of the chassis and configured to detect proximity of objects-such as tree limbs or biowaste on a forest floor—to the mobile pack. For example, the mobile pack can include ultrasonic, electromagnetic, RADAR, and/or SONAR sensors fixedly mounted or dynamically mounted to the chassis.

Therefore, the mobile pack enables an operator to traverse the array of scan zones within a set of trees according to a cruise plan—while carrying the mobile pack—to collect data of the forest and offload these data, via the local controller, to a computer system to further extract metrics and insights of the forest.

Additionally or alternatively, the mobile scanning system can be installed (e.g., mounted) on a vehicle configured to traverse the cruise path. In particular, in this variation, the mobile scanning system can include: a chassis; a boom (e.g., a mast) extending from the chassis and above the vehicle; a geolocation module (e.g., a global positioning system) coupled to the boom; a sensor suite including optical sensors (e.g., an RGB camera, a hyper-spectral camera, a LIDAR sensor, an omnidirectional camera), proximity sensors, and/or ambient condition sensors (e.g., temperature sensor, humidity/moisture sensor, light intensity sensor) coupled to the boom; an integral display (e.g., output device) removably coupled to the chassis; a housing coupled to the chassis; a wireless communications module (i.e., local controller) arranged in the housing; and a battery module arranged in the housing.

### 4. Target Route+Planning

Generally, the computer system can select a target route through a forest, the target route intersecting a set of trees proximal a powerline.

In one implementation, the computer system can access data representing the forest and generate a set of waypoints defining navigation for an operator traversing the target route through the forest. In this implementation, the computer system can: access a set of overhead images, such as aerial or satellite images from an aerial mapping service, depicting a particular set of trees within the forest; scan these overhead images representing the set of trees and the surrounding topographical features, to define a set of scan zones and detect target infrastructures near and within each scan zone, such as overhead powerlines; and define a target route intersecting the array of scan zones, such as nominally offset from trees by a predefined target offset distance (e.g., six feet), and that maintains a minimum distance (e.g., two feet) from detected target infrastructures. The computer system can then construct an ordered sequence of geospatially-referenced waypoints along the target route, such as offset by the target offset distance (e.g., six feet).

In one example, the computer system can define a target route based on a density of a set of trees within a scan zone. In particular, in response to detecting a highly dense (e.g., thick) set of trees within the scan zone, the computer system can define a “high-frequency” route such that an operator may traverse the set of trees in a tight serpentine pattern. Additionally or alternatively, in response to detecting a less dense (e.g., sparse) set of trees within the scan zone, the computer system can define a “low frequency” route such that the operator may traverse the set of trees in a loose serpentine pattern.

Accordingly, the computer system can select and/or define a target route for an operator to traverse a particular scan zone (e.g., a set of trees) proportional to a density of the scan zone.

### 5. Data Collection

Generally, the computer system can access a sequence of images captured at a mobile scanning system while an operator traverses the target route. In particular, the mobile scanning system can render a target pathway (e.g., on a display map) for execution by the operator carrying (or otherwise traveling with) the mobile scanning system through a geographic region within the set of trees and proximal a target infrastructure (e.g., a powerline). A local controller within the mobile scanning system can then detect a location of the operator proximal (e.g., within a threshold distance of, nearby) a first scan zone and trigger a set of optical sensors in the mobile scanning system to capture a sequence of images representing a first set of trees in the first scan zone.

Alternatively, the operator may manually initiate a scan for the first scan zone through a display of the mobile scanning system. The local controller can then trigger the set of optical sensors in the mobile pack to capture a sequence of images representing a first set of trees in the first scan zone while the operator navigates the target route in the first scan zone. The local controller can then identify scan completion or scan incompletion (e.g., an incomplete scan, an incomplete scan attempt) of the first scan zone and serve feedback to the operator in (near) real-time, as described in U.S. patent application Ser. No. 18/391,393, filed on 20 Dec. 2023, which is incorporated in its entirety by this reference.

Upon completion of traversal of a first scan zone, the mobile scanning system can transmit sequences of images, tagged with geospatial locations and timestamps, to a computer system for further image processing and insight derivation.

### 6. Data Aggregation

Generally, the computer system can: access sequences of images recorded by a mobile scanning system from a set of scan zones; and assemble these sequences of images into a patrol summary based on geospatial locations and time stamps associated with each image (or sequence of images) in the sequence of images.

In one implementation the computer system can: access a sequence of images depicting a set of trees within a first scan zone; for each image in the sequence of images, access a geospatial location and a timestamp; and stitch the sequence of images into a patrol summary including a map representation of the sequence of images based on the target route traversed by the operator, geospatial locations of images in the sequence of images, and timestamps of images in the sequence of images.

In particular, the computer system can generate a tree profile for each tree identified in a set of trees based on the sequence of images and/or tree characteristics based on visual features extracted from the sequence of images.

In one example, the computer system can stitch the sequence of images into a two-dimensional and/or three-dimensional representation of infrastructure and trees near infrastructure along the target route, as described herein. In particular, in this example, the computer system can access optical data (e.g., color images and depth images) and non-optical data (e.g., ambient condition data) captured by the mobile scanning system while navigating along the target route through the set of trees in real-time and/or upon termination of the flight path. The computer system can then manipulate these optical and non-optical data: to derive two-dimensional and/or three-dimensional representations of each scan zone; to assemble these representations into a two-dimensional and/or three-dimensional representation of the set of trees; to derive correlations between tree characteristics of each scan zone; to interpolate tree characteristics of the set of trees; and to compile tree characteristics into a virtual representation of tree characteristics across the set of trees.

In one implementation, the computer system can compile images captured by the mobile scanning system of the set of trees into a composite image of each scan zone and/or compile depth images captured by the mobile scanning system and combine these depth images with the color images to assemble a color three-dimensional representation of each scan zone.

### 6.1 Data Fusion

Generally, the computer system can fuse sequences of images—captured by a mobile scanning system in distinct recording sessions—into a spatial representation of a geographic area prior to deriving tree metrics and risk scores. In particular, the computer system can: align sequences of images according to geospatial locations and timestamps associated with each image; and assemble these sequences of images into a spatial representation of a set of trees and an infrastructure object proximal the set of trees in a target geographic area. Accordingly, the computer system can assemble a representation of a set of trees and proximal infrastructure based on overlapping collection paradigms, split-team data collection scenarios, or terrain obstacles preventing complete data collection in a single recording session.

### 6.2 Voice Recording+Cross-Modal Tree Annotation

Generally, the computer system can: access an audio recording (e.g., a voice memo, audio feedback) captured by an operator (e.g., a user, an arborist) while the operator traverses the target route with the mobile scanning system; identify a particular tree, in the set of trees, associated with the audio recording based on a geospatial location and a timestamp of the audio recording; extract a first set of language descriptors of the tree from the first set of scan data and a second set of language descriptors of the tree from the audio recording; align the first set of language descriptors and the second set of language descriptors via a large language model; and update tree metrics (e.g., a strike risk score, an encroachment score, a tree health score, a tree species) of the tree based on the aligned set of language descriptors. Accordingly, the computer system can incorporate field observations made by the operator into tree metrics by: aligning audio-based descriptors of the tree with image-based descriptors of the tree; and augmenting the sensor-derived risk characterization with human expertise collected during traversal of the target route.

In one implementation, the computer system can: access an audio recording associated with a first geospatial location and a first timestamp; identify a first tree, in the set of trees, associated with the first geospatial location and the first timestamp (e.g., based on proximity of the first geospatial location to a tree geospatial location of the first tree, based on an orientation of the mobile scanning system facing the first tree at the first timestamp); extract a first set of language descriptors of the first tree from the first set of scan data, the first set of language descriptors representing visual features of the first tree (e.g., “dense canopy”, “yellow foliage”, “broken limb extending over the powerline”); pass the audio recording and a prompt for tree descriptors to a large language model; and receive, from the large language model, a second set of language descriptors of the first tree extracted from the audio recording according to the prompt. The computer system can then align the first set of language descriptors and the second set of language descriptors to derive an aligned set of language descriptors for the first tree.

In particular, the computer system can extract the first set of language descriptors of the first tree from the first set of scan data by: extracting a set of visual features (e.g., canopy density, foliage color distribution, bark condition, structural lean, branch directions) of the first tree from the first set of scan data; and mapping the set of visual features to a first set of language descriptors representing the visual features in natural language (e.g., “sparse canopy”, “yellowing foliage”, “missing bark”, “leaning toward the powerline”). The computer system can implement a vision-language model (e.g., a multi-modal foundation model trained to generate natural-language captions from images) to map visual features to language descriptors.

Furthermore, the computer system can pass the audio recording and the prompt for tree descriptors to the large language model. In particular, the computer system can: extract a segment of the audio recording corresponding to the first timestamp and the first geospatial location; structure the prompt for tree descriptors specifying a set of target descriptors (e.g., “tree health”, “strike risk”, “encroachment risk”, “ease of trimming”, “estimated species”) for extraction from the audio recording; and pass the segment of the audio recording and the prompt to the large language model. In response, the large language model can extract a second set of language descriptors of the first tree from the chunk of the audio recording according to the set of target descriptors specified in the prompt and return the second set of language descriptors to the computer system.

Then, the computer system can align the first set of language descriptors with the second set of language descriptors to derive the aligned set of language descriptors. In one implementation, the computer system can: for each language descriptor in the second set of language descriptors, identify a corresponding language descriptor, in the first set of language descriptors, representing a same target descriptor (e.g., a same visual feature, a same tree characteristic); calculate a similarity score representing similarity between the language descriptor in the second set and the corresponding language descriptor in the first set; and, in response to the similarity score exceeding a threshold similarity score, include both language descriptors in the aligned set of language descriptors. In response to the similarity score falling below the threshold similarity score, the computer system can: flag a discrepancy between the audio-based descriptor and the image-based descriptor; prompt the operator to capture a second sequence of images of the first tree at a higher resolution to disambiguate the discrepancy; and re-align the audio-based descriptor against language descriptors extracted from the second sequence of images.

The computer system can then update tree metrics of the first tree based on the aligned set of language descriptors. In particular, the computer system can: calculate a strike risk score for the first tree, as described above, based on the simulated rotation of the surface of the first tree about the pivot at the base of the first tree; access an aligned language descriptor in the aligned set of language descriptors representing a tree-health condition of the first tree (e.g., “diseased”, “structurally compromised”, “dying”); and adjust the strike risk score for the first tree (e.g., increasing the strike risk score) based on the aligned language descriptor representing the tree-health condition. Accordingly, the computer system can incorporate operator-asserted field observations of tree health into the strike risk score of the first tree, capturing tree-health information that may not be readily detectable from the first set of scan data alone.

In one variation, the computer system can implement a bidirectional voice interface to guide the operator through audio-based annotation of trees in the set of trees during traversal of the target route. In particular, the computer system can: serve a confirmation to the operator via the display of the mobile scanning system that the audio recording has been correctly captured; in response to detecting a particular language descriptor in the second set of language descriptors (e.g., “may be diseased”), serve a follow-up prompt to the operator via the display of the mobile scanning system to inspect a physical feature of the tree (e.g., the root structure, the bark condition) proximal the first tree; and access a follow-up audio recording captured by the operator in response to the follow-up prompt for further refinement of the second set of language descriptors. Accordingly, the computer system can dynamically tailor the audio-based annotation workflow to the language descriptors detected in prior audio recordings, capturing higher-fidelity field observations on trees flagged as elevated strike or encroachment risks.

In another variation, the computer system can: cross-check an operator-asserted risk characterization (extracted from the audio recording via the large language model) against a sensor-derived risk characterization (extracted from the first set of scan data, as described above); and serve a discrepancy notification to the operator in response to the operator-asserted risk characterization differing from the sensor-derived risk characterization by more than a threshold difference. For example, the computer system can: access an audio recording in which the operator asserts that a particular tree should be removed; pass the audio recording and a prompt for tree descriptors to the large language model; receive, from the large language model, a second set of language descriptors representing the operator-asserted risk characterization; calculate a difference between the operator-asserted risk characterization and a strike risk score derived from visual features of the tree in the first set of scan data; and, in response to the difference exceeding a threshold difference, serve a discrepancy notification to the operator via the display of the mobile scanning system. Accordingly, the computer system can resolve discrepancies between operator-asserted and sensor-derived risk characterizations during traversal of the target route, ensuring that field observations made by experienced operators are incorporated into the final risk scores and not silently overridden by automated analysis alone.

Therefore, the computer system can implement a cross-modal alignment of audio-based and image-based language descriptors of a particular tree via a large language model to derive an aligned set of language descriptors for the tree, augment tree metrics of the tree based on the aligned set of language descriptors, and dynamically tailor the audio-based annotation workflow during traversal of the target route based on language descriptors detected in audio recordings, thereby enabling the computer system to incorporate field observations made by an operator into the final tree metrics and to capture nuanced tree-health information that may not be readily detectable from the first set of scan data alone.

### 7. Data Parsing

Generally, the computer system can: extract a set of visual features from sequences of images of a set of trees captured during a scan; derive tree characteristics of trees detected in the sequences of images based on the set of visual features; identify target infrastructures, in the sequences of images, proximal the set of trees; and characterize a risk score of each tree in the set of trees based on tree characteristics and/or proximity of a tree boundary to the target infrastructure.

### 7.1 Tree Detection+Tree Characteristics

Generally, the computer system can detect a tree, in a set of trees, from a particular image in a sequence of images depicting the set of trees.

In one implementation, the computer system can implement methods and techniques described in U.S. patent application Ser. No. 18/199,863, filed on 19 May 2023 to: detect individual trees, in a set of trees, represented in a sequence of images captured by a mobile scanning system as an operator traverses a scan zone.

Additionally or alternatively, in this implementation, the computer system can identify a set of tree characteristics (e.g., species, height, width, species, health) based on visual features in the sequence of images. In particular, in this implementation, the computer system can detect a boundary encompassing a single tree in the set of trees, such as based on: canopy density; branch groupings; branch directions; and/or trunk thickness.

The computer system can derive the set of canopy characteristics including visual features of the canopy of the tree observable from a camera-equipped mobile scanning system, such as: canopy density; foliage color distribution (e.g., yellowing, browning, or sparse foliage suggesting disease, drought stress, or senescence); canopy symmetry; evidence of broken or missing branches; canopy surface area; and the presence of pest indicators (e.g., webbing, crown dieback) visible in the canopy. Similarly, the computer system can derive the set of base characteristics including visual features extracted from images of the trunk and root collar of the tree, such as: base diameter; bark condition (e.g., missing bark, wound wood, fungal fruiting bodies); structural lean; and visible root exposure or root damage.

In one implementation, the computer system can, for each tree in the set of trees: extract a set of features of the tree from the first set of scan data; derive a tree species of the tree based on the set of features; derive a tree age of the tree based on the set of base characteristics; and characterize the tree health of the tree based on the set of features, the tree species, and the tree age.

For example, the computer system can characterize a tree health score for a particular tree as a composite of: canopy density as a proportion of expected density for the species and age; the proportion of foliage exhibiting stress coloration; the presence and severity of visible pest or disease indicators; and/or the structural integrity of the trunk and base visible in the images.

Additionally, the computer system can derive a three-dimensional tree boundary encompassing a tree. In particular, the computer system can define a foliage boundary of the tree based on the set of canopy characteristics; and derive a three-dimensional tree boundary based on a volume of the tree defined by the foliage boundary.

For example, the computer system can define a three-dimensional tree boundary (or “tree boundary”) representing a volumetric enclosure—such as a convex hull, an ellipsoidal approximation, or a higher-fidelity point-cloud surface—encompassing a tree from tree root collar to tree crown. In particular, the computer system can derive the three-dimensional tree boundary by: accessing a point cloud representation of the tree captured by a mobile scanning system; and derive the three-dimensional tree boundary based on the point cloud representation of the tree.

In one implementation, the computer system can implement computer vision techniques (e.g., object detection, edge detection, template matching) to detect visual features (e.g., bark characteristics, pixel width, foliage characteristics) of each tree depicted in a sequence of images and characterize a value of a metric associated with these visual features such as: tree type; tree species; pest risk; base diameter; fire risk; defects; carbon capture; etc. The computer system can then generate a metric function (e.g., a linear regression) representing a correlation between values of this metric and these visual features and leverage the metric function to characterize a value of the metric of each tree depicted in a second sequence of images of the set of trees.

Accordingly, the computer system can derive a comprehensive set of tree characteristics for each tree in the set of trees—including the tree health, the tree species, the tree age, and the three-dimensional tree boundary—from the sequence of images.

### 7.2 Target Infrastructure Detection

Generally, the computer system can detect a target infrastructure, proximal the set of trees, in the sequence of images, such as based on an image classification model and/or geospatial locations of the target infrastructure. In particular, the target infrastructure defines a powerline running proximal (e.g., through) a set of trees within a scan zone.

In one implementation, the computer system can: extract a set of visual features from the sequence of images; identify a powerline in the sequence of images based on the set of visual features; and annotate a representation of the scan zone with a location of the powerline represented by the set of visual features.

In another implementation, the computer system can access a scan zone characterization, such as describing characteristics of the powerline including: a powerline voltage; and/or a powerline type (e.g., distribution, transmission). The computer system can then annotate the representation of the scan zone with these powerline characteristics and/or characterize the scan zone based on these powerline characteristics.

In one variation, the computer system can: access a known location of a powerline proximal the scan zone; overlay a representation of the scan zone with the known location of the powerline; validate the known location of the powerline based on the sequence of images; and/or validate geolocations of images in the sequence of images based on the known location of the powerline.

In one implementation, the computer system can access a customer-provided vegetation management guide or infrastructure configuration specifying powerline voltage classes and regulatory distance thresholds corresponding to each voltage class. In particular, a utility operator may apply a first set of encroachment thresholds to distribution-class powerlines and a second, larger set of encroachment thresholds to transmission-class powerlines. In response to detecting distribution and transmission lines in close proximity (e.g., a double-stack configuration with transmission conductors above distribution conductors), the computer system can: identify each powerline in the scan zone based on visual features in the sequence of images and/or infrastructure records; associate each powerline with a corresponding voltage class; and apply a corresponding regulatory distance threshold for each powerline.

Accordingly, the computer system can detect a target infrastructure (e.g., a powerline) located proximal a scan zone and represent a location of the powerline in a visualization of the scan zone to thereby enable the computer system to derive insights about potential risks to the powerline as described herein.

### 7.3 Encroachment

Generally, the computer system can define an encroachment boundary around the target infrastructure (e.g., powerline); identify individual trees (and/or portions of trees) intersecting the encroachment boundary; and flag these trees for review by an operator, such as by annotating a map representation with locations of trees intersecting the encroachment boundary. In particular, the computer system can: identify a target infrastructure in an image (or a sequence of images); define an encroachment boundary encompassing the target infrastructure (e.g., a powerline) based on a regulatory threshold distance and/or an operator-defined threshold distance (e.g., regulatory distance+5 feet); detect a particular tree boundary, associated with a particular tree, intersecting the encroachment boundary, indicating that the particular tree is encroaching on the target infrastructure; and flag the particular tree for maintenance by an operator.

In one implementation, the computer system can define the threshold boundary around the infrastructure object based on a regulatory threshold distance between tree boundaries and infrastructure objects, the threshold boundary defining a cylindrical volume encompassing the infrastructure object. In particular, the computer system can: access the regulatory threshold distance between tree boundaries and overhead powerlines and define the threshold boundary based on a sum of the regulatory threshold distance between tree boundaries and overhead powerlines and an operator-defined buffer distance. For example, the computer system can: access the regulatory threshold distance (e.g., eight feet) for a particular powerline voltage class; access an operator-defined buffer distance (e.g., two feet) to account for measurement uncertainty and seasonal tree growth; and define the threshold boundary as a cylindrical volume (e.g., a ten-foot radius) centered on the powerline conductor.

In particular, the computer system can: detect an overhead powerline, proximal the set of trees, in the first set of scan data; access a regulatory threshold distance between tree boundaries and overhead powerlines; and define the threshold boundary based on a sum of the regulatory threshold distance between tree boundaries and overhead powerlines and an operator-defined buffer distance.

For example, the computer system can define the encroachment boundary based on: a distance from the powerline (e.g., +5 feet, +8 feet); a voltage of powerline; a tree species; local weather conditions (e.g., windy, high fire risk); and/or powerline type (e.g., transmission, distribution). In one example, the encroachment boundary can be defined proportional to a voltage of the powerline. In particular, the powerline can define a high voltage, and the encroachment can accordingly define a high radius around the powerline. In another example, the computer system can define the encroachment boundary based on a tree species of trees proximal the powerline. In particular, for a tree species characterized by a high shed level (e.g., palm trees), the computer system can define an encroachment boundary defined by a radius around the powerline.

In another implementation, the computer system can classify trees in the set of trees into mandatory remediation categories and discretionary remediation categories based on the threshold boundary. In particular, the computer system can: access a set of regulatory penalties associated with trees intersecting the threshold boundary, such as penalties defined by NERC or a state regulatory authority; classify trees intersecting the threshold boundary into a mandatory remediation category in response to the regulatory penalties exceeding a threshold penalty; and classify trees proximal the threshold boundary into a discretionary remediation category in response to the regulatory penalties falling below the threshold penalty.

In one implementation, the computer system can characterize an encroachment score for a particular tree in a set of trees proximal the powerline. In particular, the computer system can: calculate a distance (e.g., a closest distance) from a particular tree to the powerline; and characterize an encroachment score for the particular tree based on the distance and tree characteristics (e.g., species, growth rate, age, health) associated with the particular tree. In response to the encroachment risk for the particular tree exceeding an encroachment risk threshold, the computer system can flag the particular tree for maintenance (e.g., felling, pruning) by an operator.

In one variation, the computer system can characterize an encroachment score for each tree in the set of trees based on intersection between the three-dimensional tree boundary and a particular boundary zone of the target infrastructure object. For example, the computer system can: detect a first three-dimensional tree boundary within a first boundary zone of the target infrastructure object (e.g., within two feet); characterize the first tree, associated with the first three-dimensional tree boundary, as a first maintenance priority (e.g., urgent; address within 24 hours); detect a second three-dimensional tree boundary within a second boundary zone of the target infrastructure object (e.g., within two to six feet); characterize the second tree, associated with the second three-dimensional tree boundary, as a second maintenance priority (e.g., mild; address within days or months).

In this implementation, the computer system can: define a threshold boundary around the infrastructure object, the threshold boundary defining a cylindrical volume encompassing the infrastructure object; and calculate an encroachment score based on an intersection of the three-dimensional tree boundary with the threshold boundary around the infrastructure object. In particular, the computer system can: extract a set of features of the tree from the first set of scan data; derive a set of tree characteristics based on the set of features; define a tree boundary encompassing the tree based on the set of features; and populate a map with a tree representation of the tree boundary. The computer system can then calculate an encroachment score for the tree based on: the set of tree characteristics; a volume of the tree boundary intersecting the threshold boundary; and a distance between the tree boundary and the threshold boundary.

In this implementation, the computer system calculates the encroachment score based on tree characteristics, tree volume, and/or a distance between the tree boundary and the threshold boundary. In particular, the computer system can derive a set of tree characteristics (e.g., species, growth rate, age, health) to capture a likelihood that a tree will continue to encroach on the infrastructure object over time. For example, the computer system can characterize a tree species exhibiting a high growth rate proximal the threshold boundary as a higher encroachment risk than a slow-growing species at the same distance. Additionally, the computer system can: calculate a volume of the tree boundary intersecting the threshold boundary to capture the extent of current encroachment. In particular, the computer system can: for a first tree, derive a first volume of a first tree boundary interesting the threshold infrastructure boundary; for a second tree, derive a second volume of a second tree boundary interesting the threshold infrastructure boundary, the second volume falling below the first volume; and characterize a first encroachment score for the first tree, the first encroachment score exceeding a second encroachment score for the second tree. Furthermore, the computer system can calculate a distance between the tree boundary and the threshold boundary to capture proximity for trees that are not yet encroaching on (e.g., intersecting) the threshold boundary. In particular, the computer system can: for a first tree, calculate a first distance between a first tree boundary and the threshold boundary; for a second tree, calculate a second distance between a second tree boundary and the threshold boundary, the second distance exceeding the first distance; and characterize a first encroachment score for the first tree, the first encroachment score exceeding a second encroachment score for the second tree.

Accordingly, in this implementation, an operator may define an encroachment boundary based on a regulatory encroachment boundary based on maintenance frequency for the particular scan zone to: detect potential encroachment risks for a particular time period; and proactively mitigate these risks. The computer system can accordingly annotate a representation of the scan zone with potential encroachment risks, as described herein.

Therefore, the computer system can define an encroachment boundary around a powerline within a scan zone: to identify trees proximal the powerline; to characterize these trees as potential encroachment risks based on a distance from a tree to the encroachment boundary; and/or to identify an encroachment based on a tree boundary intersecting the encroachment boundary.

### 7.4 Strike Risk+Scoring

Generally, the computer system can calculate a strike risk score for each tree in a set of trees, the strike risk score representing a likelihood of the tree, upon felling, striking (e.g., falling onto, contacting, igniting) a target infrastructure object (e.g., a powerline, a waterline, a building, a home). In particular, the computer system can: derive a three-dimensional tree boundary representing a surface of the tree from a first set of scan data of the tree; simulate a rotation of the surface about a pivot at a base of the tree to model felling of the tree; detect intersection between the surface and the target infrastructure during the rotation; and characterize the strike risk score proportional to a quantity of the simulated rotation that exhibits the intersection between the surface and the target infrastructure. The computer system can repeat this process across each tree in the set of trees and flag a first subset of trees, in the set of trees, exhibiting strike risk scores exceeding a first threshold strike risk score as strike risks for the target infrastructure.

More specifically, the computer system can characterize the strike risk score across three risk tiers: a first tier representing trees, in the set of trees, for which the surface intersects the target infrastructure during the simulated rotation, indicating a definite strike upon felling and warranting mandatory mitigation action; a second tier representing trees for which the surface does not intersect the target infrastructure during the simulated rotation but passes within a threshold distance (e.g., five feet, ten feet) of the target infrastructure during the simulated rotation, indicating an encroachment risk and warranting discretionary mitigation action; and a third tier representing trees for which the surface passes outside the threshold distance from the target infrastructure during the simulated rotation, indicating no strike risk and no required mitigation action. Accordingly, the computer system can prioritize first-tier trees in a work plan as urgent strike risk mitigation actions, schedule second-tier trees as standard strike risk mitigation actions, and exclude third-tier trees from the work plan altogether.

In one implementation, the computer system can simulate the rotation of the surface of the tree about the pivot by: compiling the first set of scan data into a constellation of points representing the surface of the tree; defining the pivot at the base of the tree (e.g., at a centroid of the trunk on a ground surface, at an intersection of the trunk centerline and the ground surface); for each point in the constellation of points, defining a vector, in a set of vectors, extending from the pivot to the point; for each vector in the set of vectors, simulating the rotation of the vector about the pivot in the simulated felling of the tree; and, in response to the vector intersecting a representation of the target infrastructure during the rotation, flagging the tree as a strike risk for the target infrastructure. Accordingly, the computer system can simulate the rotation of every point on the surface of the tree about the pivot at the base of the tree as a discrete vector trajectory and detect, for each vector trajectory, whether the trajectory passes through the target infrastructure during the simulated rotation.

In one variation, the computer system can simulate the rotation of the vector about the pivot through each of a set of vertical planes intersecting the pivot. In particular, the computer system can: define the set of vertical planes intersecting the pivot, each vertical plane characterized by a yaw angle (e.g., 5 degrees, 15 degrees, 30 degrees) relative to a reference direction; for each vertical plane, project the vector into the vertical plane; and simulate the rotation of the vector about the pivot through the vertical plane. For example, the computer system can define the set of vertical planes including thirty-six vertical planes through the pivot, each vertical plane offset from an adjacent vertical plane by a yaw angle of ten degrees, and simulate rotation of each vector in the set of vectors through each of the thirty-six vertical planes. Accordingly, the computer system can simulate felling of the tree in many different fall directions to capture variability in fall direction (e.g., due to wind, terrain slope, asymmetric canopy, root damage) without requiring foreknowledge of the actual fall direction.

In another variation, the computer system can characterize the strike risk score proportional to a count of vector rotations, across the set of vectors and the set of vertical planes, that exhibit intersection between the vector and the target infrastructure during the rotation. For example, the computer system can: simulate rotation of each of one thousand vectors through each of thirty-six vertical planes for a total of thirty-six thousand simulated rotations of points on the surface of the tree; count three thousand simulated rotations exhibiting intersection between the vector and a representation of the powerline; and characterize the strike risk score for the tree as a fraction (e.g., 3,000/36,000=0.083) representing the proportion of simulated rotations exhibiting strike. Accordingly, the computer system can characterize the strike risk score on a continuous scale rather than as a binary classification, thereby enabling the operator to prioritize trees by relative strike risk severity within the first tier.

Additionally or alternatively, the computer system can characterize the strike risk score for the tree based on a binary outcome, such as flagging the tree as a strike risk in response to any vector in the set of vectors intersecting the target infrastructure during the rotation.

Furthermore, the computer system can characterize a strike volume representing a portion of the surface of the tree predicted to intersect the target infrastructure during the simulated rotation. In particular, the computer system can: aggregate, across the set of vectors and the set of vertical planes, the points associated with vectors that intersect the target infrastructure during the rotation; and define the strike volume as a volume bounded by the aggregated points. The computer system can then calculate the strike risk score proportional to the strike volume.

In one implementation, the computer system can identify a target removal volume of the tree corresponding to the portion of the surface predicted to intersect the target infrastructure during the simulated rotation. In particular, the computer system can: calculate a clearance distance between the surface of the tree and the target infrastructure during the simulated rotation; detect a portion of the surface of the tree within the clearance distance of the target infrastructure during the simulated rotation; and define the target removal volume including the portion of the surface within the clearance distance of the target infrastructure. Then, the computer system can generate a work plan specifying removal of the target removal volume from the tree as a strike risk mitigation action for the tree, thereby enabling the operator to dispatch a field crew to trim the target removal volume from the tree without removing the entire tree.

In another implementation, the computer system can normalize a strike risk score for a particular tree based on a set of tree characteristics (e.g., tree species, tree health, tree age) of the tree, accounting for the increased likelihood of fall in trees exhibiting disease, pest infestation, or structural failure. For example, the computer system can: calculate a first strike risk score for the tree based on intersection of the surface with the target infrastructure during the simulated rotation; access a tree health score of the tree (e.g., derived from canopy density, foliage stress coloration, pest indicators, structural lean, bark condition); and calculate a second strike risk score for the tree inversely proportional to the tree health score, the second strike risk score exceeding the first strike risk score for trees exhibiting low tree health. The computer system can then flag the tree as a strike risk in response to the second strike risk score exceeding the first threshold strike risk score.

In one variation, the computer system can derive a tree species of the tree from the set of canopy characteristics of the tree, access a growth rate associated with the tree species, and project a future three-dimensional tree boundary of the tree at a future time corresponding to predicted execution of the work plan based on a current three-dimensional tree boundary of the tree and the growth rate. The computer system can then simulate rotation of the future three-dimensional tree boundary about the pivot in a simulated felling of the tree at the future time, calculate a future strike risk score for the tree based on intersection of the future three-dimensional tree boundary with the target infrastructure during the simulated rotation, and include a strike risk mitigation action for the tree in the work plan in response to the future strike risk score exceeding the first threshold strike risk score, thereby enabling the operator to address strike risks predicted to develop within the forecast time window of the work plan.

Accordingly, in this implementation, the computer system can generate strike risk scores for trees in a set of trees to identify potential strike risks for a nearby powerline based on simulations of trees falling about a pivot at the base of the tree and flag high-risk trees for an operator.

### 7.4.1 Branch-level Strike Risk Scoring

Generally, the computer system can calculate a branch-level strike risk score for each tree in the set of trees based on individual branches of the tree extending above the target infrastructure, capturing strike risks posed by individual branches of the tree (e.g., dead branches, large limbs) independent of the overall fall trajectory of the tree.

In one implementation, the computer system can detect a set of branches of the tree extending above the target infrastructure based on the first set of scan data and, for each branch in the set of branches: calculate a branch volume of the branch based on the first set of scan data; characterize a branch health of the branch based on visual features of the branch detected in the first set of scan data; and calculate a branch strike risk score for the branch proportional to the branch volume and inversely proportional to the branch health. The computer system can then characterize a strike risk score for the tree further based on each branch strike risk score in the set of branch strike risk scores.

In particular, the computer system can characterize the branch volume of the branch based on visual features extracted from the first set of scan data, such as a length of the branch, a diameter of the branch, and a foliage density of the branch. For example, the computer system can: extract a centerline of the branch from the first set of scan data; calculate the length of the branch as a length of the centerline; calculate the diameter of the branch as a width of the centerline at a base of the branch; and characterize the branch volume as a function of the length and the diameter of the branch.

Furthermore, the computer system can characterize the branch health of the branch based on visual features extracted from the first set of scan data, such as discoloration (e.g., yellowing, browning of foliage), structural deformity (e.g., visible cracks, splits, or breaks in the branch), and bark degradation (e.g., missing bark, fungal fruiting bodies, evidence of insect bore holes) detected on the branch. In particular, the computer system can characterize the branch health of an individual branch independently of the tree health of the tree, such as in response to detecting particular dead or diseased branch, extending above the target infrastructure, on an otherwise healthy tree. For example, the computer system can: characterize a tree as exhibiting a high tree health based on canopy density, symmetry, and foliage color; and characterize a particular branch of the tree as exhibiting a low branch health in response to detecting visual features (e.g., bark loss, fungal growth, foliage absence) representing decay or structural failure of the particular branch.

Accordingly, the computer system can calculate the branch strike risk score for the branch as a function of branch volume and branch health—for example, the branch strike risk score proportional to the branch volume and inversely proportional to the branch health—such that the branch strike risk score reflects both the magnitude of damage the branch could inflict on the target infrastructure upon falling (driven by branch volume) and the likelihood of the branch falling (driven by branch health). The computer system can then aggregate branch strike risk scores across each branch in the set of branches of the tree (e.g., as a sum, as a maximum, as a weighted sum) into a tree-level branch strike risk score and combine the tree-level branch strike risk score with the simulation-based strike risk score for the tree, as described above, to characterize an overall strike risk score for the tree.

Therefore, the computer system can capture branch-level strike risks—such as a large dead limb extending over a powerline—that may not be captured by the simulation of felling of the tree as a whole, and flag trees for branch-level mitigation (e.g., pruning, crown thinning) based on branch-level strike risk scores rather than whole-tree felling simulations.

### 8. Map Visualization+Risk Indicators

Generally, the computer system can: generate a visualization (e.g., a map) of a particular geographic zone, characterized by sets of trees; annotate this visualization with locations of high-risk trees (or clusters of trees); and serve the visualization to an operator.

In particular, for each tree in the set of trees, the computer system can: populate a map with a representation of the tree in Block S154; and annotate the representation of the tree in the map with a color indicator based on the strike risk score of the tree in Block S156. In one variation, the computer system can then: detect a cluster of trees, in the set of trees, characterized by strike risk scores exceeding the first threshold strike risk score; identify the cluster of trees as a strike risk zone; and annotate a representation of the cluster of trees in the map with a second color indicator representing the strike risk zone.

For example, the computer system can generate a map of a set of trees and, for each tree in the set of trees, populate the map with a representation of the tree and annotate the representation with a color indicator based on the strike risk score of the tree. For example, the computer system can: overlay the representation of a tree characterized by a strike risk score exceeding a first threshold strike risk score with a red color indicator to flag the tree to an operator viewing the map; overlay the representation of a tree characterized by a strike risk score falling between a second threshold strike risk score and the first threshold strike risk score with a yellow color indicator; and overlay the representation of a tree characterized by a strike risk score falling below the second threshold strike risk score with a green color indicator. Accordingly, the computer system can enable an operator to rapidly identify trees characterized by high strike risks, within the set of trees, by reviewing the map.

Additionally or alternatively, the computer system can: generate a map of the first scan zone in Block S150; and populate the map with an infrastructure representation of the infrastructure object and the threshold boundary in Block S152. The computer system can then, for each tree in the set of trees: extract a set of features of the tree from the first set of scan data; define a tree boundary encompassing the tree based on the set of features; and populate the map with a tree representation of the tree boundary. The computer system can then calculate an encroachment score for the tree based on: a set of tree characteristics; a volume of the tree boundary intersecting the threshold boundary; and a distance between the tree boundary and the threshold boundary. The computer system can then: for each tree in the set of trees, annotate the tree representation in the map with a color indicator representing the encroachment score; and serve the map, annotated with color indicators representing encroachment scores of each tree in the set of trees, to an operator portal.

In one implementation, the computer system can: collect/access images captured by the mobile scanning system and generate a map (e.g., a two-dimensional map, a three-dimensional map) of the set of trees depicted in the images in (near) real-time.

In one variation, the computer system can generate and develop a two-dimensional map of the set of trees while an operator traverses along the target route for each scan zone. For example, the computer system can: access a set of high-resolution images captured by optical sensors arranged within the mobile scanning system; downsize (e.g., downsample) this set of high-resolution images into low-resolution images depicting each scan zone within the set of trees; stitch these low-resolution images into a composite (e.g., panoramic) image of the set of trees; generate a two-dimensional map of the set of trees; and, in response to receiving an operator's indication that the target route of the scan zone is complete via the display integrated into the mobile scanning system, serve this two-dimensional map of the set of trees to the operator in (near) real-time, such as presented on the display for the operator to review.

In another variation, the computer system can generate an augmented two-dimensional map of each scan zone within the set of trees and present this augmented two-dimensional map to the operator in near real-time. Further, the computer system can: access a sequence of images representing a set of trees in a first scan zone; extract a set of terrain characteristics of the scan zone from the sequence of images; transform the sequence of images into a composite image of this first scan zone; and present the augmented two-dimensional representation of the first scan zone to the operator.

For example, the computer system can: access a first set of scan data -representing a set of trees in a first scan zone-captured by the mobile scanning system and characterized by a first resolution (e.g., high-resolution); extract a set of terrain characteristics of the scan zone based on visual features detected in each image in the sequence of images; downsize the first set of scan data into a second sequence of images characterized by a second resolution less than the first resolution (e.g., low-resolution); stitch the second sequence of images into a composite image of this first scan zone; aggregate the composite image and the set of terrain characteristics into an augmented two-dimensional representation of this first scan zone; and render the augmented two-dimensional representation of the first scan zone on the display of the mobile scanning system. Then, in response to an operator selecting a first location on the augmented two-dimensional representation, the computer system can transform the augmented two-dimensional representation to display a particular image and/or panoramic image associated with a geolocation represented by the first location on the augmented two-dimensional representation.

In one implementation, the computer system can annotate a representation of a tree proportional to an encroachment score and/or a strike potential risk score of the tree. In particular, the computer system can: generate a representation of a tree (e.g., an icon, an indicator); overlay the representation of the tree with a particular color based on a risk score (e.g., encroachment score, strike potential risk score) for the tree; and render the representation of the tree on a map representing the scan zone, geolocated according to a geolocation of the tree and overlayed with the particular color.

In one example, a tree defines a “high” encroachment score (e.g., 0.9). In this example, the computer system can: generate a representation of the tree; and overlay the representation of the tree with a red color to indicate the high encroachment score and to flag the tree to an operator viewing the map. In another example, a tree defines a “medium” encroachment score (e.g., 0.5). In this example, the computer system can: generate a representation of the tree; and overlay the representation of the tree with an orange/yellow color to indicate the medium encroachment score and to flag the tree to an operator viewing the map. In yet another example, a tree defines a “low” encroachment score (e.g., 0.1). In this example, the computer system can: generate a representation of the tree; and overlay the representation of the tree with a green color to indicate the low encroachment score. The computer system can implement methods and techniques described herein for a particular encroachment score and/or for a particular strike risk score for each tree in a scan zone.

Thus, the computer system can present a two-dimensional map of each scan zone to the operator to thereby enable the operator to timely review the two-dimensional map of the scan zone and decide a mitigation strategy for reducing risk within the scan zone.

### 9. Variation: On-device+Conversational AI

In one variation, the computer system can implement on-device inference at a local controller of the mobile scanning system to derive tree characteristics and characterize a strike risk score for a particular tree in near real-time during traversal of a scan zone, thereby enabling the local controller to serve a notification to the operator via the display of the mobile scanning system indicating whether a particular tree warrants further evaluation based on a strike risk score derived on-device, without requiring the operator to manually measure the tree or await processing by a remote computer system.

In this variation, the computer system can implement a voice-to-text processing pipeline including: transcribing a voice recording, captured by an operator while the operator traverses a target path through a set of trees, into a transcription; parsing the transcription to extract a set of language signals representing tree descriptors of trees in the set of trees; and structuring the transcription into a target schema for output to an external system of record. In one variation, a controller at the mobile scanning system-in coordination with the computer system-guides operator input (e.g., voice input) via a prompt structure, such as a prompt card presented on the display of the mobile scanning system.

In this variation, the computer system can calculate a strike risk score, representing strike risk of each tree on the infrastructure object, further based on a description of a set of features of the tree and features of the tree specified in the voice recording associated with the tree. For example, for each tree in the set of trees, the computer system can calculate a strike risk score, representing strike risk of the tree on the infrastructure object further based on: a description of a set of features of the tree; and features of the tree specified in the audio recording. Accordingly, the computer system can incorporate field observations made by an operator into the strike risk score of a particular tree, augmenting the sensor-derived risk characterization with human expertise collected during traversal.

In one example, a local controller (e.g., embedded computing device, on-device processor) at a mobile pack carried by an operator can execute on-device inference to derive a first risk characterization for a particular tree at a first precision level during traversal of a scan zone, and a remote computer system can subsequently derive a second risk characterization for the particular tree at a second precision level greater than the first precision level based on the full image data received from the mobile scanning system. In this example, the local controller can preserve operator annotations and risk characterizations asserted during field traversal when deriving the second risk characterization, ensuring that field observations made by experienced operators are incorporated into the final risk scores and are not overridden by automated analysis alone.

In another variation, the computer system can implement a bidirectional voice interface to guide an operator through data collection and/or physical risk score indication for a particular tree in a scan zone. In particular, the local controller can: serve a confirmation to the operator via the display of the mobile scanning system that a voice recording has been correctly captured; and serve a follow-up prompt to the operator via the display of the mobile scanning system based on language signals extracted from a prior voice recording. For example, in response to detecting language signals in a voice recording indicating that a particular tree may be diseased, the local controller can serve a follow-up prompt to the operator to inspect a physical feature of the tree, such as the root structure or bark condition, proximal the particular tree.

In a similar variation, the computer system can prompt an operator to physically mark a particular tree for strike and/or encroachment mitigation action. In particular, during a second time period and while an operator traverses a target pathway intersecting an array of scan zones, the computer system can: access a sequence of images captured by the mobile scanning system, carried by the operator, at a first scan zone in the array of scan zones, the sequence of images depicting a set of trees occupying the first scan zone; and detect an infrastructure object, proximal the set of trees, in the sequence of images. For each tree in the set of trees, the computer system can: extract a set of canopy characteristics of the tree from the sequence of images; derive a three-dimensional tree boundary encompassing the tree based on the set of canopy characteristics; and calculate a strike risk score, representing strike risk of the tree on the second infrastructure object, based on intersection of the three-dimensional tree boundary with the second infrastructure object during simulated felling of the tree and/or calculate an encroachment score for the tree based on the set of tree characteristics and a volume of the tree boundary intersecting a threshold boundary of the infrastructure object. In response to the strike risk score and/or the encroachment score exceeding a threshold risk score, the computer system can: identify the tree as a strike risk and/or an encroachment risk for the infrastructure object; and prompt the operator to physically mark the tree for risk mitigation action (e.g., trimming, pruning, felling) while the operator traverses the target pathway intersecting the first scan zone.

In one variation, the computer system can: cross-check an operator-asserted risk characterization against visual features detected in the first set of scan data; and serve a discrepancy notification to the operator in response to the operator-asserted risk characterization differing from a risk characterization derived from the visual features. For example, the computer system can: access a voice recording in which an operator asserts that a particular tree should be removed; extract a risk characterization from the voice recording; compare the operator-asserted risk characterization to a strike risk score calculated from visual features detected in the first set of scan data; and, in response to the operator-asserted risk characterization differing from the strike risk score by more than a threshold difference, serve a discrepancy notification to the operator via the display of the mobile scanning system.

Therefore, the computer system can implement a voice-to-text processing pipeline, a bidirectional voice interface, and/or a tiered edge-cloud processing architecture to enable an operator traversing a set of trees to capture, annotate, and augment risk characterizations of individual trees in (near) real-time, thereby reducing the likelihood of requiring a second traversal of the scan zone, incorporating field observations made by the operator into strike risk scores derived by the remote computer system, and enabling the computer system to generate work plans that reflect both sensor-derived risk characterizations and human expertise collected during traversal.

### 10. Multiple Tree Risk+Visualization

Generally, the computer system can implement methods and techniques described herein for each tree in each set of trees in a scan zone to: identify an aggregate risk for the scan zone; and flag the scan zone for the operator.

In one implementation, the computer system can identify an encroachment zone, defined by a subset of trees in a set of trees, representing a portion of the subset of trees breaching an encroachment boundary for a particular target infrastructure. For example, a set of trees can define a dense canopy layer and indistinguishable clear tree boundaries. In response to detecting the dense canopy layer, the computer system can identify an encroachment zone for the set of trees (rather than for individual trees within the set of trees).

In response to identifying the encroachment zone, the computer system can identify a representation of the encroachment zone on a visualization, such as a two-dimensional or three-dimensional map of a scan zone associated with (e.g., containing) the encroachment zone. For example, the computer system can overlay the representation of the encroachment zone with a particular color corresponding to an aggregate encroachment score associated with the set of trees occupying the scan zone and/or the encroachment zone. In particular, the computer system implements methods and techniques as described herein to: overlay the representation of the encroachment zone with a red color in response to the aggregate encroachment score exceeding a first threshold risk score; overlay the representation of the encroachment zone with an orange (or yellow) color in response to the aggregate encroachment score exceeding a second threshold risk score and falling below the first threshold risk score; and/or overlay the representation of the encroachment zone with a green color in response to the aggregate encroachment score falling below the second threshold risk score.

Additionally or alternatively, the computer system can implement methods and techniques described herein for each tree in a set of trees to calculate a set of strike potential risk scores for the set of trees. In this variation, the computer system can flag a particular scan zone based on a set of strike potential risk scores for the scan zone, including the set of trees, exceeding a threshold risk score. The computer system can then overlay a representation of the scan zone (e.g., on a map) with a particular color based on the set of strike potential risk scores.

Accordingly, the computer system can present a two-or three-dimensional map of each scan zone, flagged with high-risk zones, to the operator to thereby enable the operator to timely review the scan zone and decide a mitigation strategy for reducing encroachment and/or strike risks within the scan zone.

### 10.1 Variation: Tree Clustering

In one variation, the computer system identifies a cluster of trees within the set of trees, the cluster of trees defining a dense foliage profile. In particular, in response to a confidence score for identifying a particular tree falling below a threshold confidence score indicating low confidence in disambiguating individual trees within a set of trees, the computer system can identify and/or derive characteristics of the cluster of trees. In one example, the computer system can implement a pixel classification model (e.g., segmentation, clustering) to: identify a relative density of the cluster of trees; and assign branch clusters to particular trees based on proximity to a centroid of a tree trunk. In particular, the computer system can implement methods and techniques as described herein to: identify a set of tree cluster characteristics based on visual features extracted from a sequence of images depicting the tree cluster; calculate an encroachment score and/or a strike potential risk score for the cluster of trees based on the set of tree cluster characteristics; and, in response to the encroachment score and/or a strike potential risk score exceeding a threshold risk score, flag the cluster of trees for manual risk mitigation for an operator. For example, in response to an encroachment score for the tree cluster exceeding a threshold risk score, the computer system can: highlight a branch cluster proximal the powerline and associated with the tree cluster; and recommend mitigation actions for the branch cluster, such as pruning and/or crown thinning.

The computer system can then: generate a representation of the tree cluster in a visualization of the scan zone including the tree cluster; and overlay a color indicator on the representation based on an encroachment and/or strike potential risk score exceeding a threshold risk score to flag the tree cluster for an operator. Accordingly, in this variation, the computer system can: identify encroachment and/or strike potential risk for a cluster of trees in response to identifying a dense canopy of tree branches proximal a powerline; and flag particular segments of the cluster of trees for mitigation.

### 11. Work Plan+Work Orders

Generally, the computer system can generate a work plan specifying strike risk mitigation actions and/or encroachment mitigation actions for trees in the set of trees characterized by strike risks and/or encroachment risks to the infrastructure object in Block S140. In particular, the computer system can generate a work plan that incorporates strike risk scores, encroachment scores, asset criticality, regulatory requirements, and budget constraints to prioritize maintenance actions by a ratio of risk reduction per resources allocated towards risk reduction for the set of trees. The computer system can then: serve the work plan to an operator for review; and, in response to the operator confirming the work plan, generate a work order specifying maintenance actions for trees characterized by strike risks and/or encroachment risks in the set of trees.

In particular, the computer system can generate a work order specifying removal of portions of trees proximal the infrastructure object that contribute to the strike risk score and/or the encroachment score of the tree. In one implementation, the computer system can generate a work order specifying removal of portions of a tree predicted to intersect the infrastructure object during simulated felling of the tree. For example, the computer system can: calculate a clearance distance between the three-dimensional tree boundary of the tree and the infrastructure object; detect a portion of the three-dimensional tree boundary of the tree within the clearance distance of the infrastructure object; and generate a work order specifying removal of the portion of the three-dimensional tree boundary within the clearance distance of the infrastructure object.

In one variation, the computer system can implement methods and techniques as described herein for removing portions of trees encroaching on threshold infrastructure boundaries. In particular, for each tree in the set of trees characterized by an encroachment score exceeding a threshold encroachment score, the computer system can: detect a portion of the tree boundary of the tree intersecting the threshold boundary in Block S124; and generate a work order specifying removal of the portion of the tree boundary intersecting the threshold boundary in Block S140. The computer system can then: generate a work plan specifying encroachment mitigation action for trees in the set of trees characterized by encroachment risks to the infrastructure object; serve the work plan to an operator; and, in response to the operator confirming the work plan, generate a work order specifying maintenance actions for trees characterized by encroachment risks in the set of trees.

In one implementation, the computer system can generate a work order specifying both strike risk mitigation actions and encroachment mitigation actions for trees in the set of trees. In particular, the computer system can: generate a work plan specifying strike risk mitigation actions for trees in the set of trees characterized by strike risks to the infrastructure object; and, in response to an encroachment score of a tree in the set of trees exceeding a threshold encroachment score, generate the work plan further specifying encroachment mitigation actions for trees in the set of trees characterized by encroachment risks to the infrastructure object. The computer system can then: serve the work plan to an operator; and, in response to the operator confirming the work plan, generate a work order specifying both strike risk mitigation actions and encroachment mitigation actions for trees in the set of trees.

In another implementation, the computer system can generate a work order specifying removal of portions of a tree predicted to grow toward the infrastructure object within a forecast time window. In particular, the computer system can: extract a growth rate of a tree in the set of trees based on the set of canopy characteristics of the tree; project a predicted three-dimensional tree boundary of the tree at a future time within a forecast time window based on the three-dimensional tree boundary and the growth rate of the tree; detect a portion of the predicted three-dimensional tree boundary of the tree within a clearance distance of the infrastructure object; and generate a work order specifying removal of the portion of the predicted three-dimensional tree boundary within the clearance distance of the infrastructure object. For example, the computer system can: characterize a tree species of the tree based on the set of canopy characteristics; access a growth rate associated with the tree species; project a predicted three-dimensional tree boundary of the tree at a future time twelve months from a first time window based on the growth rate; detect a portion of the predicted three-dimensional tree boundary intersecting the threshold boundary around the infrastructure object; and generate a work order specifying removal of the portion of the predicted three-dimensional tree boundary intersecting the threshold boundary.

Therefore, the computer system can: generate a work plan specifying strike risk mitigation actions and/or encroachment mitigation actions for trees in the set of trees by incorporating strike risk scores, encroachment scores, asset criticality, regulatory requirements, and budget constraints; and serve the work plan to an operator for review, thereby enabling the operator to confirm and prioritize maintenance actions across the set of trees and deploy field crews to execute targeted strike risk and encroachment mitigation actions in a single field visit.

### 11.1 Variation: Trim Lines+Simulation-Driven Trim Depth Derivation

In one variation, the computer system can generate a work plan specifying a linear trim line for a cluster of trees characterized by encroachment risks to the target infrastructure object, the linear trim line representing the linear footage and depth of trimming required to bring the cluster of trees below a target encroachment to the target infrastructure. In particular, rather than generating a per-tree work order for each tree in the cluster of trees, the computer system can: detect a linear cluster of trees, in the first subset of trees, proximal the target infrastructure object; derive a target trim depth for the linear cluster of trees by simulating the strike risk of trees in the linear cluster of trees following removal of a portion of the surface of each tree according to a candidate trim depth; and generate a work plan specifying the linear trim line spanning the linear cluster of trees and characterized by the target trim depth. The computer system can then serve the work plan to an operator for field crew execution as a single work order, specifying the linear footage of the linear trim line and the target trim depth (rather than a Series of per-tree work orders).

More specifically, the computer system can derive the target trim depth by: defining a set of candidate trim depths (e.g., one foot, two feet, four feet, eight feet, sixteen feet) for the linear cluster of trees; for each candidate trim depth in the set of candidate trim depths, simulating: removal of a portion of the surface of each tree in the linear cluster of trees according to the candidate trim depth; the strike risk of each tree in the linear cluster of trees following removal of the portion of the surface according to the candidate trim depth, as described above; for each candidate trim depth, calculating a count of trees in the linear cluster of trees exhibiting strike risk scores exceeding a first threshold strike risk score following removal according to the candidate trim depth; and selecting the target trim depth, in the set of candidate trim depths, that reduces the count of trees exhibiting strike risk scores exceeding the first threshold strike risk score below a target count (e.g., zero, one) following removal according to the target trim depth. Accordingly, the computer system can derive a minimum target trim depth required to bring the linear cluster of trees to (or below) a target strike risk threshold rather than over-Specifying or under-specifying the target trim depth.

For example, the computer system can: detect a linear cluster of fifty trees along an overhead powerline corridor; define a set of candidate trim depths including one foot, two feet, four feet, eight feet, and sixteen feet; for each candidate trim depth, simulate removal of the surface portion of each of the fifty trees within the candidate trim depth from the powerline; for each candidate trim depth, simulate the encroachment of each tree following the simulated removal and count the trees exhibiting encroachment scores exceeding the first threshold encroachment score; and select the candidate trim depth (e.g., four feet) at which the count of encroachment-risk trees falls below the target count (e.g., zero encroachment-risk trees). The computer system can then generate a work plan specifying a linear trim line spanning the fifty trees and characterized by a target trim depth of four feet, served to the operator as a single work order.

In one implementation, the computer system can derive the target trim depth subject to a target resource allocation for the linear cluster of trees. In particular, the computer system can: estimate a resource allocation value (e.g., a cost) for execution of the linear trim line at each candidate trim depth based on the candidate trim depth, the linear footage of the linear cluster of trees, and a per-foot trim rate accessed from a customer-supplied source (e.g., a rate card); access a target resource allocation for the linear cluster of trees; and select the target trim depth, in the set of candidate trim depths, that reduces the count of trees exhibiting strike risk scores exceeding the first threshold strike risk score by a maximum amount subject to the resource allocation value falling below the target resource allocation. Accordingly, the computer system can balance the cost of trimming against the reduction in strike risk to the target infrastructure, deriving a target trim depth that maximizes risk reduction within a budget constraint.

In another variation, the computer system can derive the linear trim line based on geometries of trees in the linear cluster of trees. In particular, the computer system can: derive a longitudinal axis of the linear cluster of trees (e.g., parallel to the target infrastructure); define the linear trim line as a vertical surface offset from the target infrastructure by the target trim depth and parallel to the longitudinal axis of the linear cluster of trees; and overlay the linear trim line on an aerial image of the set of trees as a single linear annotation. The computer system can then present the aerial image, annotated with the linear trim line, to the operator as a single work order specifying the linear footage and target trim depth of the linear trim line.

Therefore, the computer system can derive: a linear trim line spanning a linear cluster of trees characterized by strike risks to the target infrastructure based on simulation-driven trim depth derivation; generate crew-ready work orders specifying the linear footage and target trim depth of the linear trim line; and balance trim cost against risk reduction subject to a customer-supplied resource allocation, thereby enabling the operator to estimate resource allocation for execution of work plans more accurately, prioritize work orders by cost-benefit ratio, and deliver work orders to field crews without requiring translation between per-tree risk data and crew-executable trimming specifications.

### 11.2 Opportunistic Maintenance Actions

In one variation, the computer system can: identify trees in the set of trees that are not yet characterized by encroachment to the target infrastructure object and are predicted to exceed a first threshold encroachment score within a forecast time window of the work plan; and bundle encroachment mitigation actions for these trees into the work plan along with encroachment and/or strike risk mitigation actions for trees already characterized by encroachment on the target infrastructure object, thereby avoiding redundant field visits.

In one example, the computer system can: select a first tree, in the first subset of trees, characterized by a current strike risk to the target infrastructure object; detect an adjacent tree, in the set of trees, proximal the first tree; calculate a current strike risk score for the adjacent tree based on intersection of a current three-dimensional tree boundary of the adjacent tree with the target infrastructure object during a simulated felling of the adjacent tree, as described above; and, in response to the current strike risk score for the adjacent tree falling below the first threshold strike risk score, derive a predicted growth rate of the adjacent tree based on the set of canopy characteristics of the adjacent tree (e.g., based on a tree species and a tree age of the adjacent tree), project a predicted three-dimensional tree boundary of the adjacent tree at a future time corresponding to predicted execution of the work plan based on the current three-dimensional tree boundary and the predicted growth rate, calculate a predicted strike risk score for the adjacent tree based on intersection of the predicted three-dimensional tree boundary with the target infrastructure object during a simulated felling of the adjacent tree at the future time, and in response to the predicted strike risk score exceeding the first threshold strike risk score, include a strike risk mitigation action for the adjacent tree in the work plan with a strike risk mitigation action for the first tree.

For example, the computer system can: select a first tree, in the first subset of trees, characterized by a definite strike risk to a powerline; detect a second tree adjacent the first tree; calculate a current strike risk score for the second tree based on simulating felling of a current three-dimensional tree boundary of the second tree, the current strike risk score falling below the first threshold strike risk score; access a tree species (e.g., red maple) of the second tree based on the set of canopy characteristics of the second tree; access a growth rate (e.g., 18 inches per year) associated with the tree species; project a predicted three-dimensional tree boundary of the second tree at a future time twenty-four months from a current time based on the current three-dimensional tree boundary and the growth rate; simulate felling of the predicted three-dimensional tree boundary of the second tree about the pivot at the base of the second tree; calculate a predicted strike risk score for the second tree based on intersection of the predicted three-dimensional tree boundary with the powerline during the simulated felling at the future time, the predicted strike risk score exceeding the first threshold strike risk score; and bundle a strike risk mitigation action for the second tree (e.g., trimming the second tree to remove the predicted growth) into the work plan along with a strike risk mitigation action for the first tree (e.g., felling the first tree).

In one implementation, the computer system can predict the growth rate of the adjacent tree based on a tree species, a tree age, and environmental conditions (e.g., proximity to other trees, sun exposure, soil type) proximal the adjacent tree. In particular, the computer system can: derive the tree species and the tree age from the set of canopy characteristics; access a growth model for the tree species and the tree age; and project the predicted three-dimensional tree boundary of the adjacent tree at the future time based on the growth model. For example, the computer system can access a growth model representing average growth rate as a function of tree age, tree species, and crown competition (i.e., proximity of the adjacent tree to other trees in the set of trees) and project the predicted three-dimensional tree boundary of the adjacent tree at a future time corresponding to one scheduled trimming cycles from a current time-based on the growth model.

In a similar variation, the computer system can apply the same opportunistic logic for encroachment risks rather than strike risks. In particular, the computer system can: select a first tree, in the first subset of trees, characterized by a current encroachment risk to the target infrastructure object (e.g., the three-dimensional tree boundary of the first tree intersecting a threshold boundary around the target infrastructure object); detect an adjacent tree proximal the first tree, the adjacent tree characterized by a current three-dimensional tree boundary not intersecting the threshold boundary; project a predicted three-dimensional tree boundary of the adjacent tree at a future time based on a predicted growth rate of the adjacent tree; and, in response to the predicted three-dimensional tree boundary intersecting the threshold boundary at the future time, include an encroachment mitigation action for the adjacent tree in the work plan with an encroachment mitigation action for the first tree.

Therefore, the computer system can identify trees in the set of trees predicted to exceed a first threshold strike risk score (and/or encroachment score) within a forecast time window of the work plan and bundle mitigation actions for these trees into the work plan along with mitigation actions for trees already characterized by strike (or encroachment) risks, thereby enabling the operator to address predicted strike (or encroachment) risks during a current field visit and avoid a future field visit to address these trees once they exceed the threshold.

### 11.3 Work Order Prioritization

In one variation, the computer system can generate a work plan specifying strike risk mitigation actions and/or encroachment mitigation actions for trees in the set of trees subject to a target resource allocation (e.g., a customer budget, a target time window for execution, a target tree count) ingested by the computer system from a customer-supplied source (e.g., a budget spreadsheet, a rate card defining per-action costs for trimming and removal). In particular, the computer system can: rank trees in the first subset of trees in descending order of strike risk score; allocate the target resource allocation to strike risk mitigation actions for trees in the descending order of strike risk score, starting with the highest-ranked tree, until the cumulative resource allocation value reaches the target resource allocation; and generate the work plan specifying the strike risk mitigation actions for the trees included in the cumulative allocation up to the target resource allocation.

More specifically, the computer system can: access the target resource allocation for strike risk mitigation for the set of trees; and rank trees in the first subset of trees in descending order of strike risk score. For each tree in the first subset of trees in the descending order, the computer system can: calculate a resource allocation value for execution of a strike risk mitigation action for the tree based on a per-action cost from the rate card and a resource cost for the tree (e.g., a tree size, a tree species, a trim depth, a removal volume); maintain a running sum of resource allocation values for trees preceding the tree in the descending order; and, in response to the running sum falling below the target resource allocation, include the strike risk mitigation action for the tree in the work plan; and, in response to the running sum reaching the target resource allocation, terminate inclusion of strike risk mitigation actions in the work plan and serve the work plan to the operator via the operator portal. Accordingly, the computer system can prioritize the highest-strike-risk trees in the work plan up to the target resource allocation, ensuring that field crews address the most urgent strike risks first within the customer's budget constraint.

Additionally or alternatively, the computer system can prioritize work orders by a ratio of risk reduction per resource allocation value (e.g., dollars per unit of strike risk score reduction) rather than by raw strike risk score. In particular, the computer system can: for each tree in the first subset of trees, calculate a strike risk score reduction expected from execution of a strike risk mitigation action for the tree (e.g., the strike risk score of the tree minus a residual strike risk score expected after the mitigation action); calculate a ratio of strike risk score reduction per resource allocation value for the tree; rank the first subset of trees in descending order of the ratio; and allocate the target resource allocation to strike risk mitigation actions for trees in the descending order of the ratio until the cumulative resource allocation value reaches the target resource allocation. Accordingly, the computer system can derive the work plan that yields the largest aggregate strike risk score reduction within the target resource allocation rather than the work plan that addresses the highest-strike-risk trees.

In one implementation, the computer system can calculate the resource allocation value for execution of the work plan based on a target time window for execution. In particular, the computer system can: access a target time window for execution of the work plan; estimate an execution time for each strike risk mitigation action in the work plan based on a count of trees and an estimated time per strike risk mitigation action; and, in response to the cumulative execution time exceeding the target time window, terminate inclusion of strike risk mitigation actions in the work plan such that the cumulative execution time of the work plan falls within the target time window. In another implementation, the computer system can apply similar methods and techniques to generate a work plan subject to a target tree count by terminating inclusion of strike risk mitigation actions in the work plan once the count of trees in the work plan reaches the target tree count.

In one variation, the computer system can implement a closed-loop prioritization model to refine work plan generation based on cost-versus-risk trade-offs specific to a particular customer. In particular, after the computer system generates the work plan and serves the work plan to the operator for review, the operator can: reprioritize work orders in the work plan; modify strike risk mitigation actions specified in the work plan; and confirm or reject the work plan. The computer system can then: access operator modifications to the work plan; derive a set of cost-versus-risk trade-off preferences for the operator based on the operator modifications; and incorporate these trade-off preferences into subsequent work plan generation for the operator, thereby enabling the computer system to generate work plans that more closely reflect the operator's prioritization preferences over time.

Therefore, the computer system can generate work plans specifying strike risk mitigation actions and/or encroachment mitigation actions for trees in the set of trees subject to customer-defined resource allocations ingested from customer-supplied sources by ranking trees in descending order of strike risk score (or descending order of risk-reduction-per-cost ratio), allocating the target resource allocation down the ranked list, and refining work plan generation based on operator modifications, thereby reflecting cost-versus-risk trade-off preferences specific to each customer.

### 11.3.1 Work Order Prioritization: Storm+Public Safety Mitigation

In one variation, the computer system can: access a storm forecast associated with a geographic area containing the set of trees, the storm forecast specifying a forecast time window for a storm event in the geographic area; and, in response to the forecast time window preceding a scheduled execution time of the work plan, advance scheduled execution times of strike risk mitigation actions for trees in the first subset of trees to precede the forecast time window. Accordingly, the computer system can pre-emptively schedule strike risk mitigation for trees already characterized as strike risks in advance of an approaching storm, leveraging the existing strike risk scores rather than introducing a separate storm-derived hazard score.

In particular, the computer system can: access the storm forecast in Block S170; identify the forecast time window for the storm event in Block S172; identify trees in the first subset of trees with scheduled execution times succeeding the forecast time window; and, for each tree in the first subset of trees, advance the scheduled execution time of the strike risk mitigation action for the tree to a time preceding the forecast time window in Block S178. The computer system can then serve the work plan, including the advanced scheduled execution times, to the operator via the operator portal.

For example, the computer system can: access a storm forecast predicting a hurricane in a geographic area containing the set of trees within a 72-hour forecast time window; identify a first subset of trees in the set of trees characterized by strike risks to the target infrastructure object; advance scheduled execution times of strike risk mitigation actions for trees in the first subset of trees to precede the 72-hour forecast time window; and serve the resulting work plan to the operator via the operator portal, thereby enabling the operator to deploy field crews to remove or trim these trees before the storm arrives.

In one implementation, the computer system can additionally rank trees in the first subset of trees by strike risk score (or by risk-reduction-per-cost ratio, as described above) and advance scheduled execution times for the highest-ranked trees first, ensuring that the highest-strike-risk trees are addressed before the storm arrives even if the available crew capacity does not permit pre-storm execution of every strike risk mitigation action in the work plan.

Therefore, the computer system can pre-emptively schedule strike risk mitigation actions for trees already characterized as strike risks in advance of an approaching storm based on a storm forecast, thereby enabling the operator to proactively reduce public safety risks (e.g., personal harm, damage to buildings, power outages, road blockages) caused by trees felled during and after the storm.

### 12. Variation: Multi-Device Integration

In one variation, the computer system can serve work plans and work orders to a set of user roles (e.g., data collectors, planners, general foremen, and field tree crews) accessing the computer system through a role-specific view on a device (e.g., a desktop interface, a lightweight phone or tablet). In particular, the computer system can support work order prioritization during: data collection, in which an operator traversing a scan zone may assert a risk characterization for a particular tree via a voice recording or a prompt served to the mobile scanning system; a desktop review, in which a planner may reprioritize, modify, or confirm work orders in a work plan served to an operator portal; and crew dispatch, in which a general foreman may assign a subset of work orders in the work plan to a field crew and serve a lightweight work order view to the devices of the field crew for execution.

The computer system can also: access a set of existing tree records from a customer's system of record; match newly detected trees in the set of trees to existing tree records based on geospatial locations and tree characteristics of the newly detected trees; and deduplicate new scan records against existing tree records to avoid generating duplicate entries in the customer's system of record.

In one variation, the computer system can serve a customer-facing operator portal through which a customer may define and manage a set of business rules governing threshold boundaries, voltage-based encroachment thresholds, and regulatory distance parameters for the infrastructure objects. In particular, rather than managing per-customer configuration in internal configuration files, the computer system can: serve a customer-facing operator portal to the customer; receive a set of business rules from the customer via the operator portal, the set of business rules specifying encroachment thresholds, voltage-based rules, and regulatory distance parameters for the infrastructure object; and apply the set of business rules during calculation of encroachment scores and strike risk scores for trees in the set of trees.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor, but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A method comprising:
accessing a first set of scan data captured by a mobile scanning system, the first set of scan data representing a set of trees;
detecting an infrastructure object, proximal the set of trees, in the first set of scan data;
for a first tree in the set of trees:
extracting a set of canopy characteristics of the first tree from the first set of scan data;
detecting a canopy of the first tree, extending above the infrastructure object, based on the set of canopy characteristics;
deriving a three-dimensional tree boundary encompassing the first tree based on features of the first tree detected in the first set of scan data; and
calculating a strike risk score, representing strike risk of the first tree on the infrastructure object, based on:
the canopy of the first tree; and
intersection of the three-dimensional tree boundary with the infrastructure object during simulated felling of the first tree;
generating a work plan specifying strike risk mitigation action for trees in a first subset of trees, in the set of trees, characterized by strike risk scores exceeding a first threshold strike risk score; and
serving the work plan to an operator via an operator portal.

2. The method of claim 1, wherein calculating the strike risk score, representing strike risk of the first tree on the infrastructure object, based on intersection of the three-dimensional tree boundary with the infrastructure object during simulated felling of the first tree comprises:
defining a surface point on a surface of the first tree;
defining a pivot point proximal a base of the first tree;
defining a vector extending from the surface point to the pivot point;
simulating felling of the first tree via a rotation of the vector about the pivot point; and
in response to the vector intersecting the infrastructure object during the rotation, flagging the tree as a strike risk for the infrastructure object.

3. The method of claim 1, wherein calculating the strike risk score, representing strike risk of the first tree on the infrastructure object, based on intersection of the three-dimensional tree boundary with the infrastructure object during simulated felling of the first tree comprises:
defining a constellation of surface points representing a surface of the first tree;
defining a pivot point proximal a base of the first tree;
for each point in the constellation of surface points, defining a vector, in a set of vectors, extending from the surface point to the pivot point;
for each vector in the set of vectors, simulating felling of the first tree via a rotation of the vector about the pivot point; and
in response to the vector intersecting the infrastructure object during the rotation, flagging the tree as a strike risk for the infrastructure object.

4. The method of claim 3:
wherein simulating the rotation of the vector about the pivot point comprises:
defining a set of vertical planes intersecting the pivot point, each vertical plane in the set of vertical planes characterized by a yaw angle relative to a reference direction; and
for each vertical plane in the set of vertical planes:
projecting the vector into the vertical plane; and
simulating the rotation of the vector about the pivot point through the vertical plane; and
wherein calculating the strike risk score for the first tree in the set of trees comprises:
calculating a count of vector rotations, across the set of vectors and the set of vertical planes, exhibiting intersection between the vector and the infrastructure object during the rotation of the vector about the pivot point through the vertical plane; and
calculating the strike risk score proportional to the count of vector rotations.

5. The method of claim 1:
further comprising:
defining a threshold boundary around the infrastructure object, the threshold boundary defining a cylindrical volume encompassing the infrastructure object; and
for the first tree in the set of trees, calculating an encroachment score based on:
a volume of the three-dimensional tree boundary intersecting with the threshold boundary around the infrastructure object; and
a distance between the three-dimensional tree boundary and the threshold boundary; and
wherein generating the work plan specifying strike risk mitigation action for trees in the first subset of trees comprises:
generating the work plan specifying encroachment mitigation action for trees in a second subset of trees, in the set of trees, characterized by encroachment scores exceeding a first threshold encroachment score.

6. The method of claim 1:
further comprising:
defining a threshold boundary around the infrastructure object, the threshold boundary defining a cylindrical volume encompassing the infrastructure object; and
for a second tree in the first subset of trees:
detecting an adjacent tree, in the set of trees, excluded from the first subset of trees, and proximal the second tree; and
calculating an encroachment score for the adjacent tree based on:
a volume of an adjacent three-dimensional tree boundary of the adjacent tree intersecting with the threshold boundary around the infrastructure object; and
a distance between the adjacent three-dimensional tree boundary and the threshold boundary; and
wherein generating the work plan specifying strike risk mitigation action for trees in the first subset of trees comprises, in response to the encroachment score exceeding a threshold encroachment score, generating the work plan specifying encroachment mitigation action for the adjacent tree.

7. The method of claim 1:
further comprising, for a second tree in the first subset of trees:
detecting an adjacent tree, in the set of trees, proximal the second tree;
calculating a second strike risk score for the adjacent tree based on intersection of a second three-dimensional tree boundary of the adjacent tree with the infrastructure object during simulated felling of the adjacent tree; and
in response to the second strike risk score falling below the first threshold strike risk score:
deriving a predicted growth rate of the adjacent tree based on a second set of canopy characteristics of the adjacent tree;
generating a predicted three-dimensional tree boundary of the adjacent tree, at a future time corresponding to predicted execution of the work plan, based on the second three-dimensional tree boundary and the predicted growth rate; and
calculating a predicted strike risk score for the adjacent tree based on intersection of the predicted three-dimensional tree boundary with the infrastructure object during simulated felling of the adjacent tree; and
wherein generating the work plan specifying strike risk mitigation action for trees in the first subset of trees comprises, in response to the predicted strike risk score exceeding the first threshold strike risk score, generating the work plan specifying a strike risk mitigation action for the adjacent tree.

8. The method of claim 1, wherein generating the work plan specifying strike risk mitigation action comprises, for each tree in the first subset of trees:
calculating a clearance distance between the three-dimensional tree boundary of the tree and the infrastructure object during the simulated felling of the tree;
detecting a portion of the three-dimensional tree boundary of the tree within the clearance distance of the infrastructure object during the simulated felling of the tree;
deriving a target removal volume of the tree, the target removal volume comprising the portion of the three-dimensional tree boundary within the clearance distance of the infrastructure object during the simulated felling of the tree; and
generating the work plan specifying removal of the target removal volume from the tree as a strike risk mitigation action for the tree.

9. The method of claim 1, wherein generating the work plan specifying strike risk mitigation action comprises:
accessing a target resource allocation for strike risk mitigation for the set of trees;
ranking trees in the first subset of trees in descending order of strike risk scores for trees in the first subset of trees;
for each tree in the first subset of trees in descending order of strike risk score:
calculating a resource allocation value for execution of a strike risk mitigation action for the tree; and
in response to a sum of resource allocation values for trees preceding the tree in the descending order falling below the target resource allocation, including the strike risk mitigation action for the tree in the work plan; and
in response to the sum of resource allocation values approximating the target resource allocation, terminating inclusion of strike risk mitigation actions for trees in the first subset of trees in the work plan.

10. The method of claim 1:
further comprising detecting the set of trees in a first image in the first set of scan data, the first image excluding depiction of the infrastructure object; and
wherein detecting the infrastructure object, proximal the set of trees, in the first set of scan data comprises:
detecting the infrastructure object in a second image in the first set of scan data, the second image partially depicting the set of trees; and
based on partial depiction of the set of trees in the second image and geolocation tags of the first image and the second image:
overlaying a grid of tessellated cells onto the composite image, each cell in the grid of tessellated cells defining a geographic area of the composite image; and
for each cell in the grid of tessellated cells, fusing portions of the first image and the second image depicting a geographic area corresponding to the cell into a composite image based on geospatial locations associated with the first image and the second image; and
detecting the infrastructure object, proximal the set of trees, in the composite image.

11. The method of claim 1:
further comprising, for the first tree in the set of trees:
extracting a set of features of the first tree from the first set of scan data;
deriving a tree species of the first tree based on the set of features;
deriving a tree age of the first tree based on the set of base characteristics; and
characterizing a tree health of the first tree based on:
the set of features;
the tree species; and
the tree age; and
wherein calculating the strike risk score comprises, for the first tree in the set of trees, calculating the strike risk score proportional to the tree health of the first tree.

12. The method of claim 1:
wherein detecting the canopy of the first tree comprises detecting a set of overhang branches of the first tree, extending above the infrastructure object, based on the set of canopy characteristics; and
wherein calculating the strike risk score, representing strike risk of the first tree on the infrastructure object, comprises:
for each overhang branch in the set of overhang branches:
calculating a branch volume of the overhang branch based on the first set of scan data;
characterizing a branch health of the overhang branch; and
based on the branch volume and the branch health of the overhang branch, characterizing a branch strike risk score, in a set of branch strike risk scores, of the overhang branch on the infrastructure object representing likelihood of the overhang branch to fall on the infrastructure object; and
calculating the strike risk score, representing strike risk of the first tree on the infrastructure object, based on each branch strike risk score in the set of branch strike risk scores.

13. The method of claim 1:
further comprising:
accessing an audio recording associated with a first geospatial location and a first timestamp;
identifying the first tree, in the set of trees, associated with the first geospatial location and the first timestamp; and
extracting a first set of language descriptors of the first tree from the audio recording; and
wherein calculating the strike risk score for the first tree comprises calculating the strike risk score for the first tree further based on the first set of language descriptors of the first tree.

14. A method comprising:
accessing a first set of scan data captured by a mobile scanning system in a first scan zone, the first set of scan data representing a set of trees;
detecting an infrastructure object, proximal the set of trees, in the first set of scan data;
generating a map of the first scan zone;
defining a threshold boundary around the infrastructure object based on a regulatory threshold distance between tree boundaries and infrastructure objects, the threshold boundary defining a cylindrical volume encompassing the infrastructure object;
populating the map with an infrastructure representation of the infrastructure object and the threshold boundary;
for a tree in the set of trees:
extracting a set of features of the tree from the first set of scan data;
deriving a set of tree characteristics based on the set of features;
defining a tree boundary encompassing the tree based on the set of features;
populating the map with a tree representation of the tree boundary;
calculating an encroachment score for the tree based on:
the set of tree characteristics;
a volume of the tree boundary intersecting the threshold boundary; and
a distance between the tree boundary and the threshold boundary; and
annotating the tree representation in the map with a color indicator representing the encroachment score; and
serving the map, annotated with the color indicator representing the encroachment score of the tree in the set of trees, to an operator portal.

15. The method of claim 14:
wherein detecting the infrastructure object, proximal the set of trees, in the first set of scan data comprises detecting an overhead powerline, proximal the set of trees, in the first set of scan data;
wherein defining the threshold boundary around the infrastructure object comprises:
accessing the regulatory threshold distance between tree boundaries and overhead powerlines; and
defining the threshold boundary based on a sum of:
the regulatory threshold distance between tree boundaries and overhead powerlines; and
an operator-defined buffer distance; and
further comprising, for each tree in the set of trees characterized by an encroachment score exceeding the threshold encroachment score:
detecting a portion of a tree boundary of the tree intersecting the threshold boundary; and
generating a work plan specifying removal of the portion of the tree boundary intersecting the threshold boundary.

16. The method of claim 14, further comprising:
generating a work plan specifying encroachment mitigation action for trees in a first subset of trees, in the set of trees, characterized by encroachment scores exceeding a first threshold encroachment score; and
serving the work plan to an operator via an operator portal.

17. The method of claim 16:
further comprising, for a second tree in the first subset of trees:
detecting an adjacent tree, in the set of trees, proximal the second tree;
deriving a second three-dimensional tree boundary encompassing the adjacent tree based on features of the adjacent tree detected in the first set of scan data;
calculating a strike risk score, representing strike risk of the adjacent tree on the infrastructure object, based on intersection of the second three-dimensional tree boundary with the infrastructure object during simulated felling of the adjacent tree; and
in response to the strike risk score falling below a first threshold strike risk score:
deriving a predicted growth rate of the adjacent tree based on a second set of canopy characteristics of the adjacent tree;
projecting a predicted three-dimensional tree boundary of the adjacent tree, at a future time corresponding to predicted execution of the work plan, based on the second three-dimensional tree boundary and the predicted growth rate; and
calculating a predicted strike risk score for the adjacent tree based on intersection of the predicted three-dimensional tree boundary with the infrastructure object during simulated felling of the adjacent tree; and
wherein generating the work plan specifying encroachment mitigation action for trees in the first subset of trees comprises, in response to the predicted strike risk score exceeding the first threshold strike risk score, generating the work plan specifying a strike risk mitigation action for the adjacent tree.

18. The method of claim 16, wherein generating the work plan specifying encroachment mitigation action comprises:
detecting a linear cluster of trees, in the first subset of trees, proximal the infrastructure object;
for each candidate trim depth in a set of candidate trim depths along the linear cluster of trees, simulating removal of a portion of three-dimensional tree boundaries of trees in the linear cluster of trees according to the candidate trim depth;
deriving a target trim depth configured to reduce a count of trees in the linear cluster of trees exhibiting encroachment scores exceeding the first threshold encroachment score following removal of portions of trees, in the linear cluster of trees, according to the target trim depth; and
generating the work plan specifying a linear trim line spanning the linear cluster of trees and characterized by the target trim depth.

19. The method of claim 14, further comprising, during a second time period, while an operator traverses a target pathway intersecting an array of scan zones:
accessing a second set of scan data captured by the mobile scanning system,
carried by the operator, at a first scan zone in the array of scan zones, the second set of scan data depicting a second set of trees occupying the first scan zone;
detecting a second infrastructure object, proximal the second set of trees, in the second set of scan data; and
for a second tree in the second set of trees:
extracting a second set of canopy characteristics of the second tree from the second set of scan data;
deriving a second three-dimensional tree boundary encompassing the second tree based on the second set of canopy characteristics;
calculating a strike risk score, representing strike risk of the second tree on the second infrastructure object, based on intersection of the second three-dimensional tree boundary with the second infrastructure object during simulated felling of the second tree; and
in response to the strike risk score exceeding a threshold strike risk score:
identifying the second tree as a strike risk for the infrastructure object; and
prompting the operator to physically mark the second tree as the strike risk while the operator traverses the target pathway intersecting the first scan zone.

20. A method comprising:
during a first time period:
accessing a first set of scan data captured by a mobile scanning system, carried by an operator during the first time period and at a first scan zone, the first set of scan data representing a set of trees occupying the first scan zone;
detecting an infrastructure object, proximal the set of trees, based on the first set of scan data; and
for a tree in the set of trees:
extracting a set of canopy characteristics of the tree from the first set of scan data;
detecting a canopy of the tree based on the set of canopy characteristics;
deriving a three-dimensional tree boundary encompassing the tree based on features detected in the first set of scan data;
calculating a strike risk score, representing strike risk of the tree on the infrastructure object, based on:
the canopy of the tree; and
intersection of the three-dimensional tree boundary with
the infrastructure object during simulated felling of the tree; and
in response to the strike risk score exceeding a threshold risk score:
identifying the tree as a strike risk for the infrastructure object; and
prompting the operator to physically mark the tree as the strike risk.
